(19) United States
(12) Patent Application Publication
(10) Pub. No.: US 2026/0018761 A1
(43) Pub. Date: Jan. 15, 2026

(54) BATTERY

(71) Applicant: MURATA MANUFACTURING CO., LTD., Nagaokakyo-shi (JP)

(72) Inventor: Yusuke TANJI, Nagaokakyo-shi (JP)

(21) Appl. No.: 19/241,986

(22) Filed: Jun. 18, 2025

(30) Foreign Application Priority Data
Jul. 10, 2024 (JP) 2024-111063

(51) Int. Cl. H01M 50/578; H01M 10/0525

(52) U.S. Cl. CPC H01M 50/578; H01M 10/0525

(57) ABSTRACT

A battery is provided and incudes a safety valve, in which the safety valve includes a first metal member located on an outer side, a second metal member located an inner side, and an insulating member located between the first metal member and the second metal member, and the first metal member and the second metal member are connected to each other such that the first metal member and the second metal member straddle the insulating member, the first metal member includes a step portion and a thin portion located on an inner peripheral side of the step portion, and the first metal member has a first groove, the second metal member has a second groove, and the first groove is provided on an outer surface of the first metal member.

### CROSS REFERENCE TO RELATED APPLICATIONS

The present application claims priority to Japanese Patent Application No. 2024-111063, filed on Jul. 10, 2024, the entire contents of which are incorporated herein by reference.

### BACKGROUND

The present disclosure relates to a battery.

The battery can extract energy due to chemical change or the like as electric energy, and is used for various applications. For example, the batteries are used in mobile devices such as mobile phones, smart phones, and notebook computers.

### SUMMARY

The present disclosure relates to a battery. More specifically, the present disclosure relates to a battery including an electrode assembly composed of an electrode-constituting layer including a positive electrode, a negative electrode, and a separator.

The safety of the battery is required. For example, a battery including a safety valve capable of achieving current interruption at the time of abnormality is considered.

There is still room for development of a safety valve for achieving current interruption at the time of abnormality in terms of interruption characteristics.

The present disclosure, in an embodiment, relates to providing a battery capable of improving interruption characteristics of a safety valve.

The battery according to the present disclosure, in an embodiment, includes a safety valve,
the safety valve includes a first metal member located on an outer side, a second metal member located on an inner side, and an insulating member located between the first metal member and the second metal member, and the first metal member and the second metal member are connected to each other such that the first metal member and the second metal member straddle the insulating member,
the first metal member includes a step portion and a thin portion located on an inner peripheral side of the step portion, and
the first metal member has a first groove, the second metal member has a second groove, and the first groove is provided on an outer surface of the first metal member.

In the battery according to the present disclosure, in an embodiment, current interruption at the time of abnormality can be more suitably achieved. That is, the interruption characteristics can be improved by the safety valve in which “the first metal member has a step portion and a thin portion, and the first groove, particularly, the first groove is provided on the outer surface of the first metal member, and the second groove is provided on the second metal member”.

### BRIEF DESCRIPTION OF THE FIGURES

FIG. 1 is a schematic perspective view illustrating an appearance of a secondary battery according to an embodiment of the present disclosure;

FIG. 2 is a schematic view illustrating an internal configuration of the secondary battery according to an embodiment of the present disclosure;

FIG. 3 is a schematic perspective view illustrating constituent members and related members of a safety valve of the secondary battery according to an embodiment of the present disclosure in a developed state;

FIG. 4 is a schematic perspective view illustrating the constituent members of the safety valve of the secondary battery according to an embodiment of the present disclosure in a half and developed state;

FIG. 5 is a schematic perspective view illustrating the safety valve of the secondary battery according to an embodiment of the present disclosure in half;

FIG. 6 is a schematic sectional view of the safety valve of the secondary battery according to an embodiment of the present disclosure;

FIG. 7 is a schematic sectional view of the safety valve and a partial enlarged schematic view of a step portion of the first metal member;

FIG. 8 is a schematic sectional view of a safety cover corresponding to the first metal member and a partial enlarged view thereof;

FIG. 9A is a schematic exploded sectional view of a safety valve (excluding a top cover) of a secondary battery according to an embodiment and a schematic sectional view in a combined state;

FIG. 9B is a schematic exploded sectional view of a safety valve (excluding a top cover) of a secondary battery according to another embodiment and a schematic sectional view in a combined state;

FIG. 10 is a schematic enlarged sectional view of a thin portion and a step portion of a first metal member;

FIG. 11A is a partial sectional view and a partly enlarged sectional view of a safety valve that can correspond to a comparative example;

FIG. 11B is a partial sectional view and a partly enlarged sectional view of the safety valve of the present disclosure;

FIG. 12 is a schematic sectional view of a 2D half division model;

FIGS. 13a and 13b are schematic sectional views illustrating states of operated safety valves in Examples 1 and 2; FIGS. 13c and 13d are schematic sectional views illustrating states of the operated safety valves in Comparative Examples 1 and 2; and

FIG. 14a is a schematic sectional view illustrating a displacement ratio of a stripper disk during operation of the safety valves in Examples 1 and 2; and FIG. 14b is a schematic sectional view illustrating a displacement ratio of a stripper disk during operation of the safety valves in Comparative Examples 1 and 2.

### DETAILED DESCRIPTION

In recent years, along with a long life, a high output, and the like, performance improvement regarding reliability of a battery is required.

The inventor of the present application has found that a certain battery safety valve can achieve current interruption and the like at the time of abnormality and can cope with high output and the like, but still has room for development from another viewpoint. For example, the inventor of the present application has focused on the fact that a safety valve combined from a plurality of members is not necessarily satisfactory from the viewpoint of current interruption at the time of abnormality, and member deformation and displacement caused by an abnormal increase in battery internal pressure or the like may not be sufficient.

The safety valve of the battery can achieve current interruption and/or reduction of can internal pressure at the time of abnormality by cleaving or breaking the constituent members thereof. For example, in a battery including a safety valve including a combination of a safety cover, a stripper disk, and an insulating member therebetween, an interruption pressure can be controlled by deflection of the safety cover or the like, and a timing of groove breakage of the safety cover and the stripper disk can affect the interruption pressure.

In such a safety valve, although displacement is assumed in which the stripper disk in which cleavage and breakage have occurred is moved to the outer side (the outer side along the battery axis) by receiving the battery internal pressure, it has been found that such displacement is not necessarily desired. In particular, it has been found that the amount of displacement of the stripper disk may not be sufficient. Such an insufficient displacement amount of the stripper disk easily causes undesired re-conduction.

Undesired re-conduction due to an insufficient amount of displacement easily manifests when fusing occurs. When the groove breakage causes interruption, fusion may occur due to heat when a large current is applied. Although the interruption may function once due to fusing of the stripper disk, molten metal that can be caused by fusing easily induces re-conduction. For example, when the molten metal generated by fusing adheres to the safety cover and the stripper disk, there is a concern that a disadvantageous phenomenon such as re-conduction may occur, and the inventor of the present application has noticed that such a disadvantageous phenomenon easily manifests when the displacement amount of the stripper disk at the time of operating the safety valve is not sufficient.

In an embodiment, in the safety valve mechanism that operates at the time of abnormality, the displacement amount of the stripper disk is improved, and further, a highly reliable battery capable of reducing or avoiding undesired re-conduction as a safety valve mechanism has been achieved.

Hereinafter, the present disclosure will be described in further detail including with reference to the figures according to an embodiment. The present disclosure is not particularly limited to the description herein including the preferred embodiments and the like described herein, and can be appropriately modified. Note that, in consideration of the description of the main points or ease of understanding, embodiments and the like may be separately described for convenience, but partial replacement and/or combination of configurations described in different embodiments and the like are possible. In the description of such an embodiment, descriptions of matters common to those described above may be omitted, and only different points may be described.

Particularly, similar functions and effects achieved by similar configurations may not be mentioned sequentially for each embodiment.

In the description of the present specification, reference to a direction, an orientation, or the like is merely for convenience of description, and is not intended to limit the scope of the present disclosure unless otherwise explicitly described. For example, relative terms, such as “out (or outer side, outer portion or outer circumference)”, “in (or inner side, inner portion or inner circumference)”, “bottom”, and the like, as well as derivative terms thereof, should be understood to refer to directions as described or illustrated. That is, unless otherwise explicitly described, the invention is not required to be limited only to a specific direction, orientation, form, or the like. In addition, terms such as “provided”, “disposed”, “connected”, and “adhered”, and derivative terms thereof are also similar, and are not limited to a direct mode, and may be a mode in which another element such as an inclusion is interposed unless otherwise explicitly described.

The term “battery” in the present specification includes not only a so-called “secondary battery” but also a “primary battery”, which is capable of only discharging. That is, the “battery” in the present specification may be a “secondary battery” that can be repeatedly charged and discharged, or a “primary battery” that is substantially only discharged. The “secondary battery” is not excessively bound by the name, and may include an “electric storage device”, for example.

Hereinafter, for convenience of description, the battery according to the present disclosure will be described mainly by taking the secondary battery as an example.

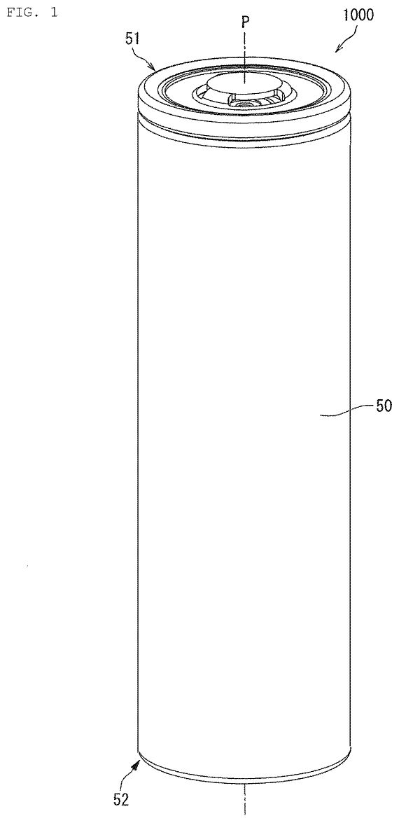

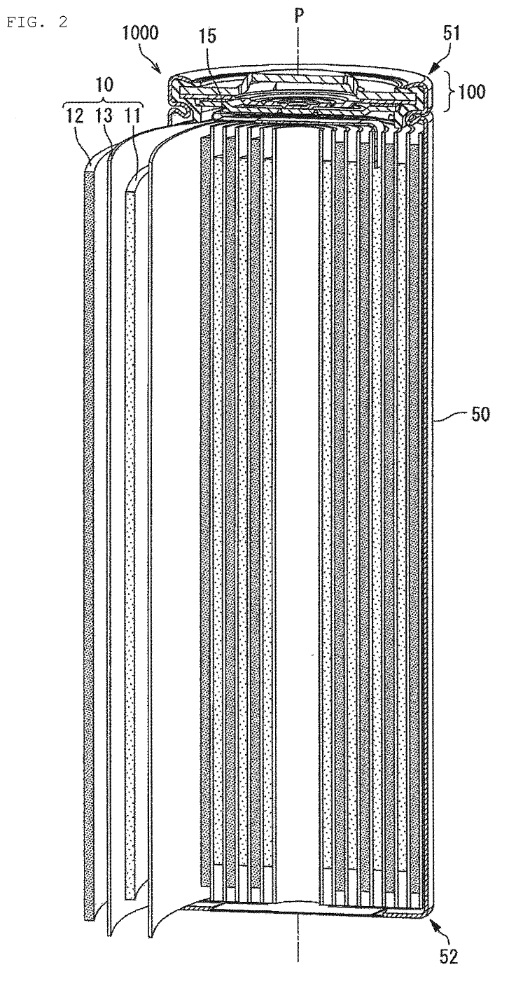

The secondary battery according to the present disclosure includes an electrode assembly formed of electrode-constituting layers, the electrode-constituting layers including a positive electrode, a negative electrode, and a separator. In the secondary battery according to the present disclosure, such an electrode-constituting layer may have a wound structure (hereinafter, also referred to as a “wound electrode body” or a “wound structure”) wound in a roll shape. FIG. 1 schematically illustrates an exemplary aspect of an external appearance of a secondary battery 1000, and FIG. 2 schematically illustrates an exemplary aspect of an internal structure thereof. As illustrated in the drawing, the electrode assembly 10 is housed inside a battery can 50. In the exemplary aspect illustrated in FIG. 2, an electrode assembly 10 has a configuration in which a positive electrode 11, a negative electrode 12, and a separator 13 disposed between the positive electrode and the negative electrode are wound. For the secondary battery 1000, such an electrode assembly 10 is enclosed together with an electrolyte (for example, a non-aqueous electrolyte) in the battery can 50.

The positive electrode is configured by at least a positive electrode material layer and a positive electrode current collector. In the positive electrode, the positive electrode material layer is provided on at least one surface of the positive electrode current collector. The positive electrode material layer contains a positive electrode active material as an electrode active material. For example, for each of a plurality of positive electrodes in the electrode assembly, the positive electrode material layer may be provided on both surfaces of the positive electrode current collector, or may be provided only on one surface of the positive electrode current collector.

The negative electrode is configured by at least a negative electrode material layer and a negative electrode current collector. In the negative electrode, the negative electrode material layer is provided on at least one surface of the negative electrode current collector. The negative electrode material layer contains a negative electrode active material as an electrode active material. For example, for each of a plurality of negative electrodes in the electrode assembly, the negative electrode material layer may be provided on both surfaces of the negative electrode current collector, or may be provided only on one surface of the negative electrode current collector.

The electrode active materials included in the positive electrode and the negative electrode, that is, the positive electrode active material and the negative electrode active material are substances directly involved in the transfer of electrons in the secondary battery, and are main substances of the positive and negative electrodes, which are responsible for charge-discharge, that is, a battery reaction. More specifically, ions are brought in the electrolyte due to the “positive electrode active material contained in the positive electrode material layer” and the “negative electrode active material contained in the negative electrode material layer”, and such ions move between the positive electrode and the negative electrode to transfer electrons, thereby performing charging and discharging. The positive electrode material layer and the negative electrode material layer may be layers particularly capable of occluding and releasing lithium ions. That is, the secondary battery according to the present disclosure may be a non-aqueous electrolyte secondary battery in which lithium ions move between the positive electrode and the negative electrode by using a non-aqueous electrolyte, whereby charging and discharging of the battery is performed. When lithium ions are involved in charge and discharge, the secondary battery according to the present disclosure corresponds to a so-called “lithium ion battery”, and includes electrodes capable of occluding and releasing lithium ions as a positive electrode and a negative electrode, and preferably includes layers capable of occluding and releasing the lithium ions.

In view of a lithium ion battery, the positive electrode active material may be a material that contributes to occlusion and release of lithium ions. That is, the positive electrode layer may contain any one type or two or more types among positive electrode materials capable of occluding and releasing lithium. From such a viewpoint, the positive electrode active material may be, for example, a lithium-containing compound. The type of the lithium-containing compound is not particularly limited, but may be, for example, a lithium-containing composite oxide and a lithium-containing phosphate compound. This is because a high energy density can be easily obtained.

The lithium-containing composite oxide is a generic name of oxides containing lithium and one or more of other elements (elements other than lithium) as constituent elements, and may have, for example, one of crystal structures such as a layered rock salt type crystal structure and a spinel type crystal structure. The lithium-containing phosphate compound is a generic name of phosphate compounds that contain lithium and one or two or more of other elements as constituent elements, and may have, for example, a crystal structure such as an olivine type crystal structure. The type of the other elements is not particularly limited as long as the element is any one or two or more of any elements. Among them, as the other elements, one or two or more of elements belonging to Groups 2 to 15 in the long-period periodic table is preferable. More specific examples thereof include nickel (Ni), cobalt (Co), manganese (Mn), and iron (Fe). This is because a high voltage can be easily obtained.

Examples of the lithium-containing composite oxide having a layered rock salt type crystal structure include compounds each represented by the following formulas (1) to (3).

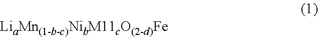

(M11 is at least one element among cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W); a to e satisfy 0.8≤a≤ 1.2, 0<b<0.5, 0≤c≤0.5, (b+c)<1, −0.1≤d≤0.2, and 0≤e≤0.1, provided that the composition of lithium varies depending on the charged and discharged states, and a is a value of a fully discharged state).

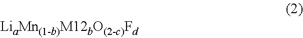

(M12 is at least one element among cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); a to d satisfy 0.8≤a≤1.2, 0.005≤b≤0.5, −0.1≤c≤ 0.2, and 0≤d≤0.1, provided that the composition of lithium varies depending on the charged and discharged states, and a is a value of a fully discharged state).

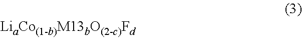

(M13 is at least one element among nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); a to d satisfy 0.8≤a≤ 1.2, 0≤b<0.5, −0.1≤c≤0.2, and 0≤d≤0.1, provided that the composition of lithium varies depending on the charged and discharged states, and a is a value of a fully discharged state).

Specific examples of the lithium-containing composite oxide having a layered rock salt type crystal structure include LiNiO₂, LiCoO₂, LiCo_{0.98}Al_{0.01}Mg_{0.01}O₂, LiNi_{0.5}Co_{0.2}Mn_{0.302}, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, and Li_{1.15}(Mn_{0.65}Ni_{0.22}Co_{0.13})O₂.

When the lithium-containing composite oxide having a layered rock salt type crystal structure contains nickel, cobalt, manganese, and aluminum as constituent elements, the atomic ratio of nickel is preferably 50 atomics or more. This is because a high energy density can be easily obtained.

Examples of the lithium-containing composite oxide having a spinel type crystal structure include a compound represented by the following formula (4).

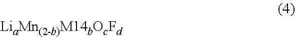

(M14 is at least one element among cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); a to d satisfy 0.9≤a≤1.1, 0≤b≤0.6, 3.7≤c≤4.1, and 0≤d≤0.1, provided that the composition of lithium varies depending on the charged and discharged states, and a is a value of a fully discharged state).

Specific examples of the lithium-containing composite oxide having a spinel type crystal structure include LiMn₂O₄.

Examples of the lithium-containing phosphate compound having an olivine type crystal structure include a compound represented by the following formula (5).

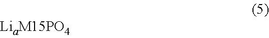

(M15 is at least one element among cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), and zirconium (Zr); a satisfies 0.9≤a≤1.1, provided that the composition of lithium varies depending on the charged and discharged states, and a is a value of a fully discharged state).

As specific examples, the lithium-containing phosphate compound having an olivine type crystal structure may be LiFePO₄, LiMnPO₄, LiFe_{0.5}Mn_{0.5}PO₄, LiFe_{0.3}Mn_{0.7}PO₄, and the like.

The lithium-containing composite oxide may be a compound represented by the following formula (6).

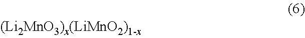

(x satisfies 0≤x≤1, provided that the composition of lithium varies depending on the charged and discharged states, and x is a value of a fully discharged state).

In addition to these, the positive electrode material may be any one type or two or more types among, for example, oxides, disulfides, chalcogenides, and conductive polymers. Examples of the oxide include titanium oxide, vanadium oxide, and manganese dioxide. Examples of the disulfide include titanium disulfide and molybdenum sulfide. The chalcogenide is, for example, niobium selenide or the like. The conductive polymer may be, for example, sulfur, polyaniline, polythiophene, or the like. However, the positive electrode material is not particularly limited, and other materials other than the above materials may be used.

The positive electrode material layer may contain a binder. In addition, the positive electrode material layer may include a positive electrode conductive agent in order to facilitate electron transfer promoting the battery reaction. The positive electrode binder may include, for example, any one or one or more types of synthetic rubbers and polymer compounds. The synthetic rubber is, for example, styrene-butadiene-based rubber, fluorine-based rubber, and ethylene propylene diene. The polymer compound is, for example, polyvinylidene fluoride, polyimide, or the like. The positive electrode conductive agent may contain any one type or two or more types among, for example, carbon materials. The carbon material may be, for example, graphite, carbon black, acetylene black, ketjen black, or the like. However, the positive electrode conductive agent may be a metal material, a conductive polymer and the like as long as they are materials exhibiting conductivity.

Similarly, the negative electrode active material of the negative electrode material layer may be a material that contributes to occlusion and release of lithium ions. That is, the negative electrode layer may contain any one or two or more among negative electrode materials capable of occluding and releasing lithium. From such a viewpoint, the negative electrode active material may be, for example, various carbon materials, metal-based materials, and/or other materials.

When a carbon material is used as the negative electrode active material, a change in the crystal structure at the time of occlusion of lithium and at the time of release of lithium is significantly small, and thus a high energy density is easily obtained stably. In addition, the carbon material also functions as a negative electrode conductive agent, and thus the conductivity of the negative electrode layer is easily improved.

Specific examples of the carbon material include graphitizable carbon, non-graphitizable carbon, and/or graphite. More specifically, the carbon material may be, for example, pyrolytic carbons, cokes, glassy carbon fiber, organic polymer compound fired body, activated carbon, or carbon blacks. The cokes may include pitch coke, needle coke, and petroleum coke. The organic polymer compound fired body is, for example, a material obtained by firing (carbonizing) a polymer compound such as phenol resin and furan resin at an appropriate temperature. In addition, the carbon material may be low crystalline carbon subjected to a heat treatment at a temperature of about 1000° C. or less, or may be amorphous carbon. The shape of the carbon material is not particularly limited, and may be at least one of a fibrous shape, a spherical shape, a granular shape, and a scaly shape.

The “metal-based material” used as the negative electrode active material is a generic term for materials containing any one type or two or more types among metal elements and metalloid elements as constituent elements. When the carbon material is used as the negative electrode active material, a high energy density can be easily obtained. The metal-based material may be a single metal, an alloy, a compound, two or more of these, or a material at least a portion of which has one or one or more of these phases. However, the alloy includes a material containing one or more types of metal elements and one or more types of metalloid elements in addition to a material composed of two or more types of metal elements. The alloy may also contain a non-metallic element. The construction of this metal-based material may be, for example, a solid solution, a eutectic (eutectic mixture), an intermetallic compound, and a material in which two or more among these coexist. The metal element and metalloid element described above may be, for example, any one type or two or more types among metal elements and metalloid elements capable of forming an alloy with lithium. Specific examples of the metal element and the metalloid element may include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc, hafnium (Hf), zirconium, yttrium (Y), palladium (Pd), and/or platinum (Pt). In a preferred aspect, the metal element or metalloid element is silicon and tin. This is because the ability to occlude and release lithium is excellent and thus a higher energy density can be easily obtained. The material containing silicon as a constituent element may be a simple substance of silicon, an alloy of silicon, or a compound of silicon, may be two or more thereof, or may be a material at least a portion of which has one or two or more of these phases. Similarly, the material containing tin as a constituent element may be a simple substance of tin, an alloy of tin, or a compound of tin, may be two or more thereof, or may be a material at least a portion of which has one or two or more of these phases. The “simple substance” described herein is a simple substance in a general sense to the utmost, and thus the simple substance may contain a small amount of impurities. That is, the purity of the simple substance is not necessarily limited to 100%. The alloy of silicon contains, for example, any one or two or more of tin, nickel, copper, iron, cobalt, manganese, zinc, indium, silver, titanium, germanium, bismuth, antimony, chromium, and the like as constituent elements other than silicon. The compound of silicon contains, for example, any one or two or more of carbon, oxygen, and the like as constituent elements other than silicon. The compound of silicon may contain, for example, any one or two or more of a series of elements described in the alloy of silicon as constituent elements other than silicon. Specific examples of the alloy of silicon and the compound of silicon include SiB₄, SiB₆, MgSi, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤ 2), and/or LiSiO. In SiOᵥ, “v” may be 0.2<v<1.4. The alloy of tin may contain, for example, any one or two or more types of silicon, nickel, copper, iron, cobalt, manganese, zinc, indium, silver, titanium, germanium, bismuth, antimony, chromium, and the like, as constituent elements other than tin. The compound of tin may contain, for example, any one or two or more of carbon, oxygen, and the like, as constituent elements other than tin. The compound of tin may contain any one or two or more of a series of elements described in the alloy of tin, for example, as constituent elements other than tin. Specific examples of the alloy of tin and the compound of tin include SnO_{w} (0<w≤ 2), SnSiO₃, LiSno, and/or Mg₂Sn. In particular, the material containing tin as a constituent element may be, for example, a material containing a second constituent element and a third constituent element together with tin, which is a first constituent element (tin-containing material). The second constituent element may be, for example, any one or two or more of cobalt, iron, magnesium, titanium, vanadium, chromium, manganese, nickel, copper, zinc, gallium, zirconium, niobium, molybdenum, silver, indium, cesium (Ce), hafnium (Hf), tantalum, tungsten, bismuth, silicon, or the like. The third constituent element may be, for example, any one or two or more of boron, carbon, aluminum, phosphorus, and the like. This is because a high battery capacity, excellent cycle characteristics, and the like can be easily obtained. Among these, the tin-containing material may be a material containing tin, cobalt, and carbon as constituent elements (tin cobalt carbon-containing material). This is because a high energy density can be easily obtained. In the tin cobalt carbon-containing material, at least a portion of carbon as a constituent element may be bonded to a metal element or metalloid element as other constituent elements. This is because the aggregation of tin, crystallization of tin, and the like are easily suppressed. The tin cobalt carbon-containing material is not limited to a material that contains only tin, cobalt, and carbon as constituent elements (SnCoC). This tin cobalt carbon-containing material may further contain, for example, any one or two or more of silicon, iron, nickel, chromium, indium, niobium, germanium, titanium, molybdenum, aluminum, phosphorus, gallium, bismuth, and the like as a constituent element in addition to tin, cobalt, and carbon. In addition to the tin cobalt carbon-containing material, a material (tin cobalt iron carbon-containing material) containing tin, cobalt, iron, and carbon as constituent elements may be employed.

In addition to these, the negative electrode material may be any one type or two or more types among, for example, metal oxides and polymer compounds. Examples of the metal oxide include iron oxide, ruthenium oxide, and molybdenum oxide. Examples of the polymer compound include polyacetylene, polyaniline, and polypyrrole.

The negative electrode material layer may contain a binder. Further, a negative electrode conductive agent may be included in the negative electrode material layer to facilitate the transfer of electrons promoting the battery reaction. The binder that can be included in the negative electrode material layer is not particularly limited, and examples thereof include at least one selected from the group consisting of styrene-butadiene rubber, polyacrylic acid, polyvinylidene fluoride, polyimide-based resins, and polyamideimide-based resins. The negative electrode conductive agent that can be included in the negative electrode material layer is not particularly limited, but examples thereof include at least one selected from carbon blacks such as thermal black, furnace black, channel black, ketjen black, and acetylene black, graphite, carbon fibers such as carbon nanotube and vapor-grown carbon fiber, metal powders such as copper, nickel, aluminum, and silver, and polyphenylene derivatives. The negative electrode material layer may contain a component derived from a thickener component (for example, a carboxymethyl cellulose) used at the time of producing the battery.

The positive electrode current collector and the negative electrode current collector used for the positive electrode and the negative electrode are members that contribute to collecting and supplying electrons generated in the electrode active material due to the battery reaction. Such an electrode current collector may be a sheet-shaped metal member. The electrode current collector may have a single layer or multiple layers. Further, the electrode current collector may have a porous or perforated form. For example, the current collector may be a metal foil, a punching metal, a net, an expanded metal, or the like. The positive electrode current collector that is used for the positive electrode may be composed of, for example, a metal foil including at least one selected from the group consisting of aluminum, nickel, stainless steel, and the like. On the other hand, the negative electrode current collector that is used for the negative electrode may be made of, for example, a metal foil containing at least one selected from the group consisting of copper, aluminum, nickel, stainless steel, and the like.

The separator used for the positive electrode and the negative electrode is a member provided from the viewpoints of the prevention of short circuit due to contact between the positive and negative electrodes and the holding of the electrolyte and the like. In other words, the separator is a member that separates the positive electrode and the negative electrode, and allows ions (for example, lithium ions) to pass while preventing a short circuit of a current due to contact between both electrodes. For example, the separator may be a porous or microporous insulating member, which may have a film form due to its small thickness.

This separator may be, for example, any one type or two or more types among porous films of synthetic resins and/or ceramics and may be a stacked film of two or more types of porous films. The synthetic resin used for the separator is, for example, polytetrafluoroethylene, polypropylene, polyethylene, or the like. For example, the separator may include the porous film (substrate layer) and a polymer compound layer provided on one side or both sides of the base layer. This is because the close contact property of the separator with respect to the positive electrode is improved as well as the close contact property of the separator with respect to the negative electrode can be improved, and thus the distortion of the wound electrode body is easily suppressed. The polymer compound layer may contain, for example, any one or two or more types of polymer compounds such as polyvinylidene fluoride. Excellent physical strength and electrochemical stability can be easily obtained. For example, the polymer compound layer may contain any one or two or more types of insulating particles such as an inorganic particle. The type of inorganic particles may include aluminum oxide and/or aluminum nitride. In the present disclosure, the separator is not to be particularly limited by its name, and may be, for example, a solid electrolyte, a gel-like electrolyte, and/or an insulating inorganic particle having a similar function.

In the secondary battery of the present disclosure, the electrode assembly including the electrode-constituting layer including the positive electrode, the negative electrode, and the separator may be enclosed in the outer case together with an electrolyte. The electrolyte may be a so-called “non-aqueous” electrolyte.

The electrolyte may typically be an electrolytic solution. The electrolytic solution includes a solvent and an electrolyte salt. The electrolytic solution may further include any one or two or more of other materials such as additives. In a preferred aspect, the separator may be impregnated with an electrolytic solution, and the positive electrode and/or the negative electrode may also be impregnated with an electrolytic solution.

The solvent may contain any one or two or more of non-aqueous solvents such as organic solvents. The electrolytic solution containing a non-aqueous solvent can be a so-called non-aqueous electrolytic solution. Examples of the non-aqueous solvent include a cyclic carbonate ester, a chain carbonate ester, a lactone, a chain carboxylate ester, and/or a nitrile (for example, mononitrile). This is because more excellent battery capacity, cycle characteristics, and/or storage characteristics can be easily obtained. Examples of the cyclic carbonate ester include ethylene carbonate, propylene carbonate, and/or butylene carbonate. Examples of the chain carbonate ester include dimethyl carbonate, diethyl carbonate, ethyl methyl carbonate, and/or methyl propyl carbonate. Examples of the lactone include γ-butyrolactone and/or γ-valerolactone. Examples of the chain carboxylate ester include methyl acetate, ethyl acetate, methyl propionate, ethyl propionate, methyl butyrate, methyl isobutyrate, methyl trimethylacetate, and/or ethyl trimethylacetate. Examples of the nitrile include acetonitrile, methoxyacetonitrile, and/or 3-methoxypropionitrile. Examples of the non-aqueous solvent include 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N, N-dimethylformamide, N-methylpyrrolidinone, N-methyloxazolidinone, N,N′-dimethylimidazolidinone, nitromethane, nitroethane, sulfolane, trimethyl phosphate, and/or dimethyl sulfoxide. In particular, the non-aqueous solvent preferably contains one or two or more of ethylene carbonate, propylene carbonate, dimethyl carbonate, diethyl carbonate, ethyl methyl carbonate, and the like. This is because higher battery capacity, further improved cycle characteristics, and/or more excellent storage characteristics can be easily obtained. In addition, examples of the non-aqueous solvent include an unsaturated cyclic carbonate ester, a halogenated carbonate ester, a sulfonate ester, an acid anhydride, a dicyano compound (dinitrile compound), a diisocyanate compound, a phosphate ester, and/or a chain compound having a carbon-carbon triple bond. This is because chemical stability of the electrolytic solution is easily improved. The “unsaturated cyclic carbonate ester” as used herein is a cyclic carbonate ester having one or two or more unsaturated bonds (carbon-carbon double bonds or carbon-carbon triple bonds). Examples of the unsaturated cyclic carbonate ester include vinylene carbonate, vinyl ethylene carbonate, and/or methylene ethylene carbonate. The “halogenated carbonate ester” is a cyclic or chain carbonate ester having one or two or more halogen elements as constituent elements. When the halogenated carbonate ester contains two or more halogens as a constituent element, the type of the two or more halogens may be one type or two or more types. Examples of the cyclic halogenated carbonate esters include 4-fluoro-1,3-dioxolan-2-one and/or 4,5-difluoro-1,3-dioxolan-2-one. Examples of the chain halogenated carbonate esters include fluoromethyl methyl carbonate, bis(fluoromethyl) carbonate, and/or difluoromethyl methyl carbonate. Examples of the sulfonate ester include a monosulfonate ester and/or a disulfonate ester. The monosulfonate ester may be a cyclic monosulfonate ester or a chain monosulfonate ester. Examples of the cyclic monosulfonate ester include sultones such as 1,3-propane sultone and/or 1,3-propene sultone. Examples of the chain monosulfonate ester include a compound in which a cyclic monosulfonate ester is cleaved in the middle. The disulfonate ester may be a cyclic disulfonate ester or a chain disulfonate ester. Examples of the acid anhydride include carboxylic anhydrides, disulfonic anhydrides, and/or carboxylic sulfonic anhydrides. Examples of the carboxylic anhydride include succinic anhydride, glutaric anhydride, and/or maleic anhydride. Examples of the disulfonic anhydride include ethanedisulfonic anhydride and/or propanedisulfonic anhydride. Examples of the carboxylic sulfonic anhydrides include anhydrous sulfobenzoic acid, anhydrous sulfopropionic acid, and/or anhydrous sulfobutyric acid. Examples of the dinitrile compound include a compound represented by NC—R1-CN (R1 is an alkylene group or an arylene group). Examples of the dinitrile compound include succinonitrile (NC—C₂H₄—CN), glutaronitrile (NC—C₃H₆—CN), adiponitrile (NC—C₄H₈—CN), and phthalonitrile (NC—C₆H₄—CN). Examples of the diisocyanate compound include a compound represented by OCN—R2-NCO (R2 is an alkylene group or an arylene group). Examples of the diisocyanate compound include hexamethylene diisocyanate (OCN—C₆H₁₂—NCO). Examples of the phosphate ester include trimethyl phosphate and triethyl phosphate. The chain compound having a carbon-carbon triple bond is a chain compound having one or two or more carbon-carbon triple bonds (—C≡C—). This chain compound having a carbon-carbon triple bond may be propargyl methyl carbonate (CH≡C—CH₂—O—C(═O)—O—CH₃) and propargyl methanesulfonate (CH═C—CH₂—O—S(═O)₂—CH₃).

For example, the electrolyte salt included in the electrolytic solution may be any one or two or more of salts such as a lithium salt. The electrolyte salt may contain a salt other than a lithium salt, for example. The salt other than lithium may be, for example, salts of light metals other than lithium. Examples of the lithium salts include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and/or lithium bromide (LiBr). This is because more excellent battery capacity, cycle characteristics, and/or storage characteristics can be easily obtained. Among these, any one type or two or more types among lithium hexafluorophosphate, lithium tetrafluoroborate, lithium perchlorate, and lithium hexafluoroarsenate may be employed.

A battery can used in a secondary battery corresponds to a member enclosing an electrode assembly in which electrode-constituting layers including a positive electrode, a negative electrode, and a separator are stacked as a battery package. The battery can may have, for example, a hollow structure in which one end portion is closed and the other end portion is opened (opened as an opening end portion). The battery can is not particularly limited, but may be a metal can containing any one of, or two or more of metal materials such as iron, aluminum, stainless steel, and alloys thereof. One or more of metal materials such as nickel may be plated on the surface of the battery can, for example. A safety valve may be provided at the opening end of the battery can. Although it is merely an example, a safety valve may be provided at the opening end of the battery can together with a thermal resistor or the like with a gasket interposed therebetween (that is, the battery safety valve may be provided together with a caulking mechanism).

The battery of the present disclosure has features related to its safety mechanism. In particular, it has a feature related to a safety valve provided on a can (particularly, an opening end thereof) of a battery.

The safety valve provided in the battery of the present disclosure includes at least a first metal member, a second metal member, and an insulating member positioned therebetween. The first metal member is positioned relatively on an outer side in the battery axial direction, while the second metal member is positioned relatively on an inner side in the battery axial direction, and they are electrically connected to each other. Preferably, the first metal member and the second metal member are connected to each other across the insulating member. Each of the first metal member and the second metal member may be a disk-shaped member. Each of the first metal member and the second metal member may have, for example, a shape extending in the battery width direction as a whole. That is, each of the first metal member and the second metal member may have a form extending as a whole in a direction orthogonal to the battery axial direction. The insulating member preferably has an opening part or a hollow portion in an inner side or central region thereof, and may have a plate shape (for example, a flat plate shape) or a flat shape as a whole, as will be described later. In the present disclosure, the first metal member, the second metal member, and the insulating member are preferably disposed so as to be directly stacked on each other, and constitute a thin safety valve.

In the safety valve according to the present disclosure, portions specific to both the first metal member and the second metal member are provided. Specifically, the first metal member has a step portion and a thin portion, and has a first groove, and the second metal member has a second groove.

The first metal member is displaced by receiving the battery internal pressure at the time of abnormality, thereby contributing to the function of the safety valve. More specifically, when the second metal member is broken starting from the second groove, the first metal member can bend together with the broken second metal member, and the current interruption is performed through such displacement. In the present disclosure, the specific elements (at least the four elements) of the first metal member and the second metal member contribute to improvement of the interruption characteristic in the action of the safety valve.

In the abnormal current interruption, the safety valve in which “the first metal member has a step portion and a thin portion, the first metal member is provided with a first groove, particularly, the first groove is provided on an outer surface (outer surface when viewed along the battery axial direction) of the first metal member, and the second metal member is provided with a second groove” according to the present disclosure can improve the amount of displacement of the stripper disk during the operation thereof. As a result, it becomes easy to reduce or avoid unintended re-conduction after breakage of the second metal member that contributes to current interruption, and interruption characteristics are improved. That is, a more reliable battery can be provided. In addition, when the reliability is increased as described above, the predictability as the behavior at the time of abnormal increase in the internal pressure is improved, and a battery having a higher degree of freedom in design can be achieved.

Hereinafter, such a battery of the present disclosure will be described in detail with appropriate reference to the drawings according to an embodiment. A configuration of a safety valve of a battery according to the present disclosure includes at least a first metal member, a second metal member, and an insulating member positioned therebetween. As one specific exemplary embodiment, an aspect in which the first metal member corresponds to a safety cover and the second metal member corresponds to a stripper disk will be described below as an example.

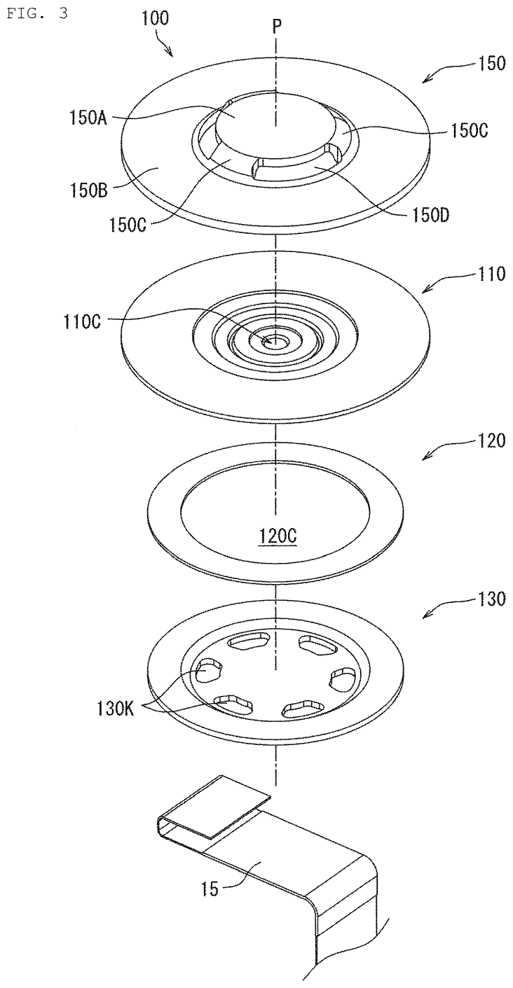

FIGS. 1 and 2 schematically illustrate an appearance of a secondary battery according to an embodiment of the present disclosure and a sectional view thereof. As illustrated, the secondary battery 1000 of the present disclosure may be a cylindrical secondary battery (for example, a cylindrical non-aqueous secondary battery). In other words, the secondary battery of the present disclosure may include a cylindrical case, that is, a cylindrical battery can 50. The safety valve 100 may be provided at a cylindrical end portion of the secondary battery 1000 (particularly, an opening end side of the battery can). FIG. 3 illustrates the safety valve 100 in a developed state together with its related members (or peripheral members), and FIG. 4 illustrates each constituent member of the safety valve 100 as a half perspective view.

As illustrated in FIGS. 3 and 4, the safety valve 100 has a configuration in which a safety cover 110 provided as a first metal member, an insulating member 120, and a stripper disk 130 provided as a second metal member are combined with each other in this order along a battery axis P. When viewed along the axial direction of the cylindrical shape of the battery, the safety cover 110 of the first metal member is positioned relatively on an outer side of the battery (that is, for example, the side farther from the electrode assembly such as the wound structure), while the stripper disk 130 of the second metal member is positioned relatively on an inner side of the battery (that is, for example, a side closer to an electrode assembly such as a wound structure), and the insulating member 120 is interposed between the safety cover 110 and the stripper disk 130. In the present specification, the “battery axis” refers to an axis P extending in a direction perpendicular to an end surface (particularly, a virtual planar end surface) of the battery can so as to pass through the center of the battery can corresponding to the battery package (refer to FIGS. 1 and 2). For example, it can be said that the battery axis refers to an axis that passes through the center of an exterior body 50 and extends in a direction orthogonal to the extending direction of the safety valve 100. In addition, it can be said that the battery axis is an axis extending between both terminals so as to pass through the center of both terminals. Therefore, an expression such as “battery axial direction” described above or below refers to a direction along the battery axis.

Each member constituting the safety valve 100 will be described in detail. The safety valve 100 contributes to a battery terminal (that is, one of the positive electrode terminal and the negative electrode terminal as the external terminal of the battery) and includes a mechanism that can be displaced in response to an excessive internal pressure of the battery. Therefore, the safety valve 100 includes the safety cover 110 and the stripper disk 130 that can be displaced according to the excessive battery internal pressure, and at least includes the insulating member 120 therebetween as a component. Such a safety valve 100 may be provided at one end portion of the battery can, and is provided at an opening end 51 in the battery can 50 of FIGS. 1 and 2. In the safety valve 100, a top cover 150 may be further provided on an outer side in the battery axial direction with respect to the safety cover 110 provided as the first metal member (refer to FIGS. 3 and 4).

The safety cover 110 provided as the first metal member mainly corresponds to a displaceable member that can close the opening end 51 of the battery can 50 and can be displaceable and/or openable in response to an increase in the internal pressure of the battery can. The internal pressure of the battery can increases due to a side reaction such as a decomposition reaction of the electrolytic solution, for example. That is, a gas such as carbon dioxide is generated inside the battery can when a side reaction such as a decomposition reaction of the electrolytic solution occurs, and thus the internal pressure of the battery can undesirably increases according to an increase of the generation amount of the gas.

The safety cover 110 may be a metal member. For example, the safety cover 110 may include any one of, or two or more of metal materials such as aluminum (for example, aluminum metal or aluminum alloy, such as A1050, A3203, and/or A5052), iron (Fe), titanium (Ti), platinum (Pt), and gold (Au). In other words, it can be said that the safety cover 110 may be a member made of such a conductive material. A planar shape of the safety cover 110, particularly an outer ring contour shape in a plan view (hereinafter, also referred to as an “outer contour shape in a plan view”) is not particularly limited, but may be, for example, a circular shape, a polygonal shape, or another shape. The circular shape is, for example, a true circle (perfect circle), an ellipse, a substantial circle, or the like. The substantial circle is, for example, a generic name of a some or all distorted shape of a true circle. The polygons are, for example, triangles, squares, pentagons and hexagons. The other shapes are, for example, shapes other than a circle whose contour is formed only by a curve, shapes in which two or more types of polygons are combined, and shapes in which one or more types of circles and one or more types of polygons are combined. Such a definition of “circular” and the like is the same hereinafter. In the shown exemplary aspect, the outer contour shape of the safety cover 110 in a plan view is circular.

The safety cover 110 may have, for example, a plate shape as a whole. That is, the safety cover 110 may have a form extending as a whole in a direction orthogonal to the battery axial direction. The safety cover 110 extending in the battery width direction as a whole as described above contributes to thinning of the battery safety valve. Although it is merely an example, the thickness of the safety cover 110 may be substantially constant except for local regions such as a stepped portion, a thin portion, and a groove provided on the safety cover.

The insulating member 120 is interposed between the safety cover 110 and the stripper disk 130, and corresponds to a member that enables at least the safety cover 110 and the stripper disk 130 to be connected to each other. The insulating member 120 may have an annular shape as a whole. That is, the shape of the insulating member 120 in a plan view may be a loop shape, a ring shape, or the like. Due to such a loop shape or ring shape, the inner side region of the insulating member 120 forms a hollow portion or an opening region 120C (that is, “cavity” described later). An outer contour shape of such an insulating member 120 in a plan view is not particularly limited, but may be the same as the outer contour shape of the safety cover 110 in a plan view, and may be, for example, a circular shape. The loop shape or ring shape of the insulating member 120 may be provided as the whole member (refer to FIG. 3), or the loop shape or ring shape may be locally divided. Further, the insulating member 120 may have, for example, a flat plate shape as a whole. That is, the insulating member 120 may have a form extending on the same plane as a whole. Such an insulating member 120 extending on the same plane contributes to a reduction in thickness of the battery safety valve. Although it is merely an example, the insulating member 120 may have a substantially constant thickness between the safety cover 110 and the stripper disk 130. Preferably, the insulating member 120 may be interposed between the safety cover 110 and the stripper disk 130 such that the opening region 120C of the insulating member 120 is positioned in the region including the battery axis.

The insulating member 120 has an insulating property, and thus electrical conduction via the insulating member 120 is preferably prevented. The term “insulation” as used herein may have an electrical resistivity, that is, the insulation property of a general insulator, and therefore may have an electrical resistivity of the general insulator, and may have a resistivity of at least 1.0×10⁵ Ω·m or more, preferably 1.0×10⁶ Ω·m or more, and more preferably 1.0×10⁷ Ω·m or more (room temperature: 20° C.) although it is merely an example.

In a preferred aspect, the insulating member 120 interposed between the safety cover 110 and the stripper disk 130 may contribute to insulation, and may not necessarily be bonded thereto. On the other hand, for example, when bonded, the insulating member 120 may be interposed between the safety cover 110 and the stripper disk 130 as an adhesive layer. The insulating member 120 may be interposed between the safety cover 110 and the stripper disk 130 such that the opening region 120C of the insulating member 120 is positioned in the region including the battery axis.

The insulating member 120 is preferably composed of a resin material. That is, the main component of the insulating member may be a resin material, or the insulating member may be configured to include at least a resin in the material of the member. When formed of a resin material as described above, the insulating member 120 more suitably contributes to the adhesiveness between the safety cover 110 and the stripper disk 130 while securing the insulating property, and furthermore, the insulating member 120 suitably contributes to the realization of a thinner safety valve. In particular, in the present disclosure, it is easy to achieve a thinner safety valve that easily suppresses or avoids re-conduction of an undesired current. When the insulating member 120 is composed of a resin material, for example, the insulating member 120 may be composed of a thermosetting resin, a thermoplastic resin, and/or a UV curable resin. When a viewpoint of connectivity is particularly emphasized, the insulating member 120 may be a member including a resin adhesive having the insulating property. Examples of such a resin adhesive include an acrylic-based resin adhesive such as acrylic acid ester copolymers, a rubber-based resin adhesive such as natural rubber, a silicone-based resin adhesive such as silicone rubber, a urethane-based resin adhesive such as a urethane resin, an α-olefin-based resin adhesive, an ether-based resin adhesive, an ethylene-vinyl acetate resin-based resin adhesive, an epoxy resin-based resin adhesive, a vinyl chloride resin-based resin adhesive, a chloroprene rubber-based resin adhesive, a cyanoacrylate-based resin adhesive, an aqueous polymer-isocyanate-based resin adhesive, a styrene-butadiene rubber-based resin adhesive, a nitrile rubber-based resin adhesive, a nitrocellulose-based resin adhesive, a reactive hot-melt-based resin adhesive, a phenol resin-based resin adhesive, a modified silicone-based resin adhesive, a polyamide resin-based resin adhesive, a polyimide-based resin adhesive, a polyurethane resin-based resin adhesive, a polyolefin resin-based resin adhesive, a polyvinyl acetate resin-based resin adhesive, a polystyrene resin solvent-based resin adhesive, a polyvinyl alcohol-based resin adhesive, a polyvinyl pyrrolidone resin-based resin adhesive, a polyvinyl butyral resin-based resin adhesive, a polybenzimidazole-based resin adhesive, a polymethacrylate resin-based resin adhesive, a melamine resin-based resin adhesive, a urea resin-based resin adhesive, and/or a resorcinol-based resin adhesive.

The insulating member 120 has a cavity 120C at a position corresponding to a central portion 110C of the safety cover 110 (refer to FIGS. 3 and 4). The cavity 120C corresponds to an inner side opening region or a hollow region of the insulating member that provides the insulating member 120 with an annular shape (loop shape or ring shape). The cavity 120C of the insulating member 120 may be provided in a region including the battery axis. The opening shape of the cavity 120C of the insulating member 120 (particularly, in a plan view, the planar opening shape) is not particularly limited, and may be, for example, the same as the outer contour shape of the safety cover 110 in a plan view. In the illustrated exemplary embodiment, the opening shape of the cavity 120C of the insulating member 120 is circular.

The stripper disk 130 provided as the second metal member is disposed relatively on an inner side of the battery with respect to the safety cover 110 with the insulating member 120 interposed therebetween, and corresponds to a member that contributes to current interruption at the time of abnormality and/or, for example, passage or release of gas inside the battery can.

The stripper disk 130 may be a metal member. For example, the stripper disk 130 may include any one of, or two or more of metal materials such as aluminum (for example, aluminum metal or aluminum alloy, such as A1050, A3203, and/or A5052), iron (Fe), titanium (Ti), platinum (Pt), and gold (Au). In other words, the stripper disk 130 may be a member composed of such a conductive material. The material of the stripper disk 130 may be the same as or different from the material of the safety cover 110. The outer contour shape of the stripper disk 130 in plan view is not particularly limited, but is, for example, similar to the outer contour shape of the safety cover 110 in plan view. In the shown exemplary aspect, the outer contour shape of the stripper disk 130 in plan view is circular.

The stripper disk 130 may have a shape extending in the battery width direction, for example, a disk shape as a whole. That is, the stripper disk 130 may have a form extending as a whole in a direction orthogonal to the battery axial direction. The stripper disk extending in the battery width direction as a whole as described above contributes to thinning of the battery safety valve. For example, the stripper disk may have a substantially constant thickness dimension.

The stripper disk 130 may be provided with a plurality of cavities 130K. The plurality of cavities 130K mainly correspond to ventilation ports that contribute to passage or release of gas inside the battery can. For example, the plurality of cavities 130K may be provided in a region on the outer peripheral side of the central region 130C.

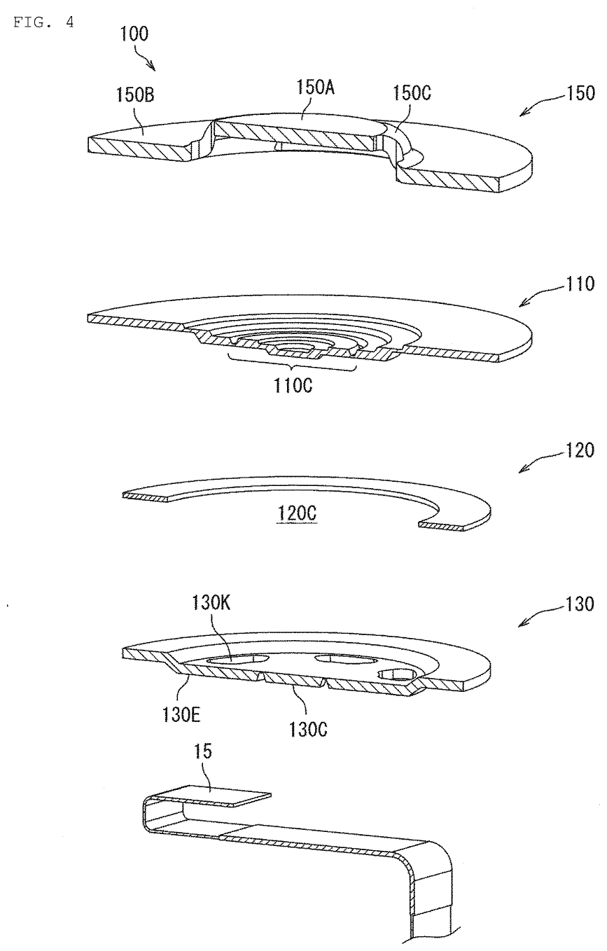

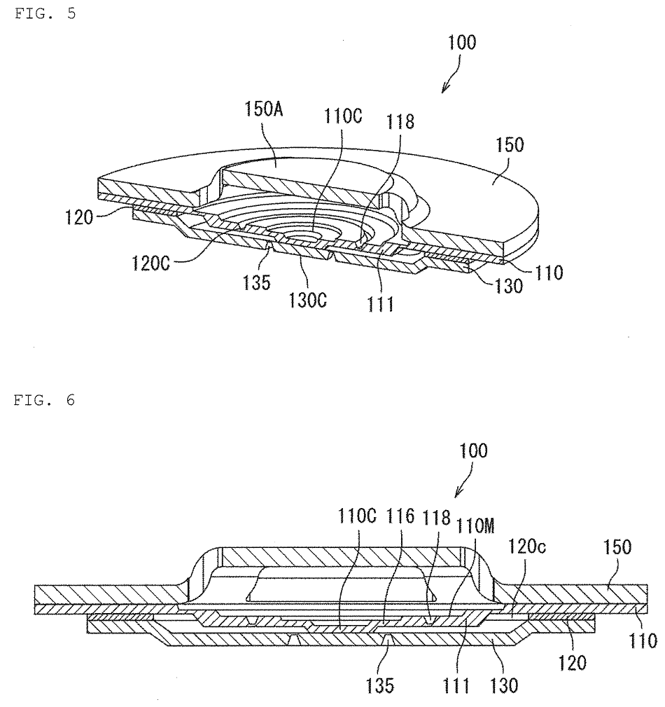

In the safety valve, the safety cover 110 and the stripper disk 130 are integrated as a whole by interposing the insulating member 120 therebetween, but the safety cover 110 and the stripper disk 130 may be electrically connected to each other in a central region thereof. For example, the safety cover 110 may be directly connected to the central region 130C of the stripper disk 130 so as to straddle the insulating member 120. More specifically, as illustrated in FIGS. 5 and 6, the central region 110C of the safety cover 110 and the central region 130C of the stripper disk 130 may be directly connected to each other through the cavity 120C of the insulating member 120.

As described above, the safety valve may further include the top cover 150. That is, the top cover 150 may be further provided on an outer side of the safety cover 110 provided as the first metal member in the battery axial direction. In the safety valve, the top cover 150 is preferably electrically connected to the safety cover 110. The top cover corresponds to a battery cover provided to cover the opening end of the battery can together with other components of the safety valve. In other words, the safety cover 110 is connected to the top cover 150 forming an external terminal of the battery. As shown in FIGS. 3 and 4, the top cover 150 has a convex portion 150A raised on an outer side in the battery axial direction (for example, raised so as to be curved). In particular, the convex portion 150A is provided in the central region of the top cover. The convex portion 150A of the top cover 150 has a form in which an annular region of the top cover is at least partly raised (for example, raised so as to be curved), and a shape in which a central region or an inner side region of the top cover is raised or protruded to an outer side of the battery. Therefore, the top cover 150 includes at least one bent portion 150C extending from the flat plate portion 150B toward an outer side of the battery, and the bent portions 150C are separated from each other (refer to FIG. 3). A cavity 150D is provided in the top cover 150 due to the separation of the bent portion. Such a top cover 150 can suitably function as a terminal of the battery. For example, the top cover 150 functions as a positive electrode terminal of the battery, and the battery can functions as a negative electrode terminal. In such a case, the top cover and the battery can may be insulated from each other. For example, the top cover may be insulated from the battery can by interposing an insulating material between the top cover and the battery can. Although it is merely an example, a safety valve including a top cover may be provided on the battery can with an insulating material interposed between the top cover and the battery can having a narrowed or constricted portion in some parts. Further, as another example, the top cover and the battery can may be insulated from each other by interposing a holder member (particularly, an insulating holder member/not shown) provided so as to support the first metal member at a peripheral edge of the safety cover provided as the first metal member (in such a case, the battery can may not be the “battery can having a narrowed or constricted portion in some parts” described above, and thus may be a non-narrowed or non-constricted battery can). The cavity 150D of the top cover 150 can act as a discharge hole for discharging a gas generated inside the battery to the outside of the battery. The material of the top cover 150 may be metal. For example, the top cover 150 may be composed of a conductive material such as steel such as iron (Fe) and SPCC, stainless steel (SUS) such as SUS430 and SUS304, nickel (Ni), aluminum (Al), and/or titanium (Ti).

A conductive member 15 extending from the electrode assembly 10 is connected to the safety valve. The conductive member 15 is electrically connected to the electrode assembly 10 (in particular, one of the positive electrode and the negative electrode), and contributes to electrical connection between the electrode assembly 10 and the safety valve (in particular, the stripper disk 130). More preferably, the conductive member 15 may be connected to a region on an outer side of the central region 130C of the stripper disk 130 corresponding to the second metal member, preferably a region (that is, a region positioned on a side farther from the interruption groove with respect to the battery axis) on the outer peripheral side of the groove (particularly interruption groove). In the safety valve, the stripper disk 130 is electrically connected to the safety cover 110 with the central region 130C interposed therebetween, and the safety cover 110 is connected to the top cover 150 forming an external terminal of the battery. Therefore, the electrode assembly 10 such as the wound structure is electrically connected to the battery external terminal with the conductive member 15 interposed therebetween. In the present specification, the conductive member 15 may be a member containing metal, and preferably may be a metal member having an elongated shape. For example, the conductive member may include an electrode current collector of the electrode assembly, or may be a current collecting lead (that is, the lead) provided in the electrode assembly (in particular, the electrode). When the conductive member is made of the electrode current collector, the conductive member may be made of a metal portion of the electrode current collector where the electrode material is not provided. When the conductive member is formed of a current collecting lead, the conductive member may be formed of a metal member having a thin form and/or a long form. In the present disclosure, the conductive member electrically connecting the electrode assembly and the electrode terminal to each other can also be referred to as a “tab”. The conductive member used for such a secondary battery preferably has flexibility, and may be provided in a bent form and/or a bent form.

In the safety valve according to the secondary battery of the present disclosure, the safety cover 110 provided as the first metal member, the insulating member 120, and the stripper disk 130 provided as the second metal member are combined so as to be stacked on each other. More specifically, as illustrated in FIGS. 5 and 6, the safety cover 110 provided as the first metal member and the insulating member 120 are disposed so as to be stacked on each other, the insulating member 120 and the stripper disk 130 provided as the second metal member are disposed so as to be stacked on each other, and the top cover 150 is disposed so as to be stacked on the safety cover 110 provided as the first metal member. In such a combination of safety valves, the stripper disk 130 provided as the second metal member is provided with a groove that contributes to current interruption at the time of abnormality, that is, the second groove 135. An opening may be provided in a portion of the second groove 135.

When the internal pressure of the battery can abnormally increases, the stripper disk 130 can be broken starting from the second groove 135, and the following disadvantageous current can be interrupted. It is assumed that the pressure inside the battery can increases due to side reactions such as a decomposition reaction of the electrolytic solution or other factors. First, when the internal pressure of the battery, that is, the internal pressure of the battery can is in the normal range, the battery safety valve does not particularly operate. That is, the stripper disk 130 and the safety cover 110 have not yet been displaced. When a gas is generated due to a side reaction such as a decomposition reaction of the electrolytic solution inside the battery can, the gas is accumulated in the battery can, so that the internal pressure of the battery can increases. When the internal pressure of the battery can continues to increase, the safety cover 110 is affected by the increase in the internal pressure. This is because the safety cover 110 and the inside of the battery can 50 are in fluid communication with each other while the stripper disk 130 is provided with the plurality of cavities 130K (refer to FIGS. 3 and 4). When the internal pressure of the battery can exceeds a certain predetermined pressure, the stripper disk 130 is pulled by the safety cover 110, and the stripper disk 130 is broken starting from the groove 135. This is because the stripper disk 130 and the safety cover 110 are connected to each other in the central region thereof, and particularly the central region 130C of the stripper disk 130 is pulled on an outer side in the battery axial direction due to the force received from the safety cover 110 that tries to be displaced by receiving the internal pressure. That is, when the tensile force acting on the central region 130C exceeds a certain limit, the stripper disk 130 is broken starting from the second groove 135 positioned around the central region. When such breakage of the stripper disk 130 occurs, the safety cover 110 is electrically separated from a non-central region 130E (in particular, a non-central region 130E of a peripheral edge portion to which conductive members, such as tabs and leads, extending from the electrode assembly are still connected) of the stripper disk 130. Therefore, the electrical connection between the top cover 150 and the electrode assembly is disconnected, and the path of the current flowing between the electrode assembly and the top cover 150 is interrupted. In this manner, the current interruption can be achieved at the time of abnormality such as an increase in internal pressure.

When the safety valve is operated, the stripper disk 130 may be broken as described above, but the inventor of the present application has found the re-conduction in which current conduction occurs thereafter despite such breakage. In particular, although the stripper disk may be displaced on an outer side (outer side in the battery axial direction) along with the breakage, when the displacement is insufficient, unintended re-conduction easily occurs after the breakage of the stripper disk. More specifically, the amount of displacement of the stripper disk after the breakage may not be sufficient, which may easily cause undesired current re-conduction.

The inventors of the present application have extensively conducted studies on such matters, and as a result, have finally arrived at the present disclosure capable of improving the above-described displacement amount when a safety valve is operated. Specifically, it has been found that the displacement amount of the stripper disk due to the breakage of the stripper disk contributing to current interruption can be improved by setting the configuration of the safety valve to “the configuration in which the first metal member has both step portion and thin portion, the first groove is provided on outer surface of the first metal member, and the second groove is provided on the second metal member”. That is, adopting such a specific safety valve configuration may provide a highly reliable battery that easily suppresses or avoids undesired re-conduction during operation of the safety valve.

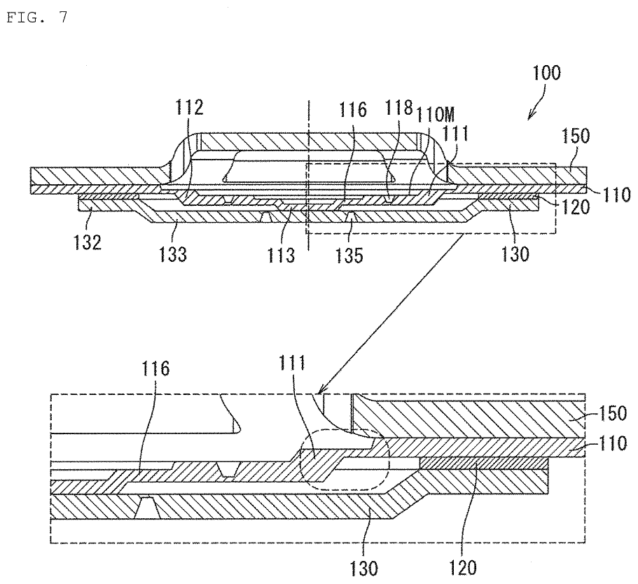

In the following, such a specific configuration will be described in more detail with reference to the drawings. FIG. 7 illustrates a sectional view of a safety cover 110 and a stripper disk 130 together with the peripheral members thereof. As illustrated, in the sectional view, the safety cover 110 includes a step portion 111, a thin portion 116 provided apart from the step portion 111, and a first groove 118. On the other hand, the stripper disk 130 has a second groove 135. The first groove 118 of the safety cover 110 is a groove portion provided on an outer side of the safety cover. That is, the first groove 118 is provided on the outer surface of the safety cover 110, particularly, the battery axial direction outer surface 110M that is the outer side when viewed along the battery axial direction. Such a configuration of the safety cover and the stripper disk allows improvement in the displacement amount of the stripper disk at the time of operation of the safety valve. Therefore, it is easy to suppress and avoid re-conduction at the time of operation of the safety valve. For example, the displacement amount of the stripper disk at the time of operation of the safety valve may be greater, thereby easily suppressing and avoiding re-conduction.

In the present specification, the term “sectional view” related to the expression “sectional view of the safety valve” or the like is based on a section that can be obtained by cutting the safety valve in a plane along the battery axis. A case where each member constituting the safety valve is cut along the thickness direction is based on the virtual section of, for example, the case where a safety cover, a stripper disk, or the like is cut along the thickness direction.

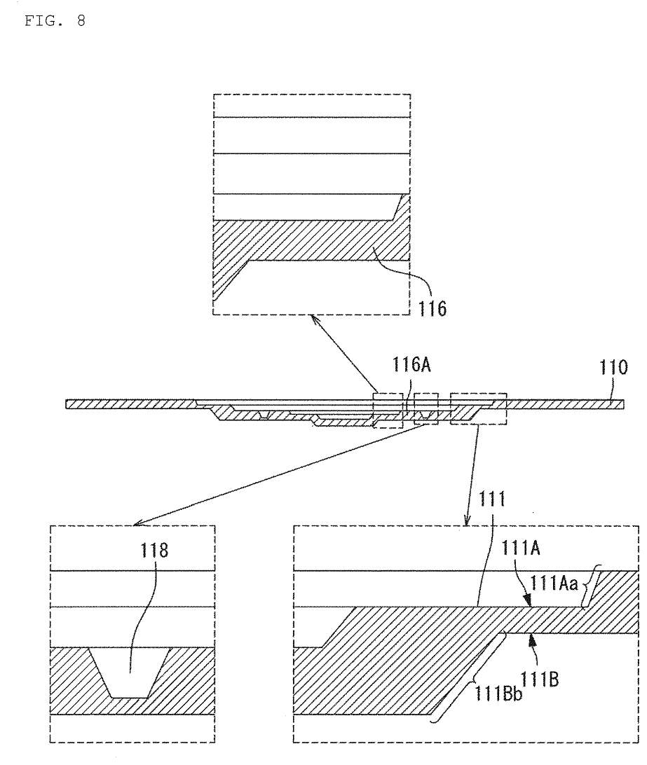

As illustrated in the sectional view of FIG. 8, the safety cover 110 corresponding to the first metal member has a step portion 111 in the sectional view thereof. In a preferred aspect, in a sectional view, the step portion 111 is provided such that the outer contour of the first metal member has a step contour and the inner contour of the first metal member also has a step contour. More specifically, in the sectional view of the safety valve, the step portion 111 is provided such that the outer contour of the first metal member positioned relatively on an outer side in the battery axial direction has a stepped contour, and the inner contour of the first metal member positioned relatively on inner side in the battery axial direction also has a stepped contour. In the aspect illustrated in the lower right of FIG. 8, in the safety cover 110 corresponding to the first metal member, the outer contour is a contour 111A positioned relatively outside in the battery axial direction, and the inner contour is a contour 111B positioned relatively on the inner side in the battery axial direction. The outer contour 111A has a stepped contour 111Aa in a portion thereof, and the inner contour 111B also has a stepped contour 111Bb in a portion thereof. The step portion may be provided, for example, in a circumferential shape in the first metal member. That is, in plan view of the first metal member (for example, the safety cover), the step portion may be continuously or intermittently provided so as to form an annular contour.

When such a step portion 111 is provided, stress at the time of operating the safety valve can be effectively applied to the safety valve. In particular, in combination with the “thin portion” and the “first groove provided on outer surface of first metal member” and the “second groove provided in the second metal member”, the step portion can effectively provide stress for displacement of the stripper disk, which contributes to improvement of the displacement amount of the stripper disk at the time of operation of the safety valve.

As illustrated in the sectional view of FIG. 8, the safety cover 110 corresponding to the first metal member also includes the thin portion 116 at a position different from the step portion. In the first metal member, the thin portion is positioned on the inner peripheral side of the step portion, that is, closer to the battery axis. That is, as illustrated in FIG. 8, in the safety cover 110, the thin portion 116 is positioned closer to the battery axis P than the step portion 111, while the step portion 111 is positioned farther from the battery axis P than the thin portion 116.

The thin portion 116 is a portion having a relatively reduced thickness in the first metal member. Therefore, the portion is a portion in which the member thickness is relatively reduced as compared with other portions (excluding grooves and the like, for example, excluding the first groove, step portion, and the like) of the first metal member. For example, as illustrated in FIG. 8, the thin portion 116 may have a thickness dimension smaller than a predetermined portion 116A of the first metal member located on the outer peripheral side of the thin portion.

When such a thin portion 116 is provided, stress at the time of operation of the safety valve can be effectively applied to the safety valve. In particular, in combination with the presence of the “step portion” and the “first groove provided on outer surface of first metal member” and the “second groove provided in the second metal member”, the thin portion 116 may provide a stress effective for the displacement of the stripper disk, which contributes to improvement of the displacement amount of the stripper disk at the time of the operation of the safety valve.

For example, the thin portion 116 of the first metal member is preferably in a predetermined thickness range. More specifically, the thickness dimension of the thin portion 116 may have a thickness ratio of 0.7 or less with respect to the non-thin thickness dimension corresponding to the thickness dimension of the member region adjacent thereto. That is, in the first metal member, the thickness dimension of the thin portion 116 may have a thickness ratio of 0.7 or less with respect to the thickness dimension of an adjacent member portion (for example, adjacent member portion 116A on the outer peripheral side) not having the thin form. The lower limit value of such a thin thickness dimension is not particularly limited, but may be, for example, 0.2, 0.3, 0.4, 0.5, 0.6, or the like with respect to the non-thin thickness dimension.

As illustrated in the sectional view of FIG. 8, the safety cover 110 corresponding to the first metal member has the first groove 118. The first groove 118 may be positioned between the step portion 111 and the thin portion 116 in the first metal member. That is, in the safety cover 110, the first groove 118 may be positioned more proximally with respect to the battery axis P than the step portion 111, and may be positioned farther from the battery axis P than the thin portion 116. It can also be said that the first groove 118 may be positioned on the inner peripheral side of the step portion 111 and on the outer peripheral side of the thin portion 116.

The first groove 118 may have a notched form or a carved form in a sectional view. Because of the groove, the first groove 118 may have a shoulder contour that forms a pair in a sectional view (refer to the lower left of FIG. 8). It can also be said that the first groove may have a line-symmetric contour in a sectional view. For example, the first groove 118 may be a so-called “imprint groove” or a groove formed through press molding. In such a first groove 118, the width dimension of the groove may gradually change. That is, the separation distance of the groove contours facing each other in the sectional view may gradually decrease toward the groove bottom. In addition, because of the groove, the first groove may have a depth of half or more of the thickness of the member. That is, the groove depth dimension of the first groove may be half or more of the thickness dimension of the first metal member. Herein, the thickness of the first metal member particularly refers to a member thickness at a portion other than the step portion and the thin portion.

Such a first groove is provided on the outer surface (that is, inner surface in the battery axial direction) of the first metal member. That is, in the first metal member, the first groove is not provided on the inner main surface thereof, but is particularly provided on the outer main surface (a surface located on the outer side when viewed along the battery axial direction). As illustrated in the sectional view of FIG. 8, it can be said that the first groove 118 opens upward or outward from the battery in the safety cover 110. In combination with the “step portion”, “thin portion”, and “second groove provided on the second metal member”, the first groove provided on the outer surface of such a first metal member can effectively provide stress for displacement of the stripper disk, which contributes to improvement of the displacement amount of the stripper disk at the time of operation of the safety valve.

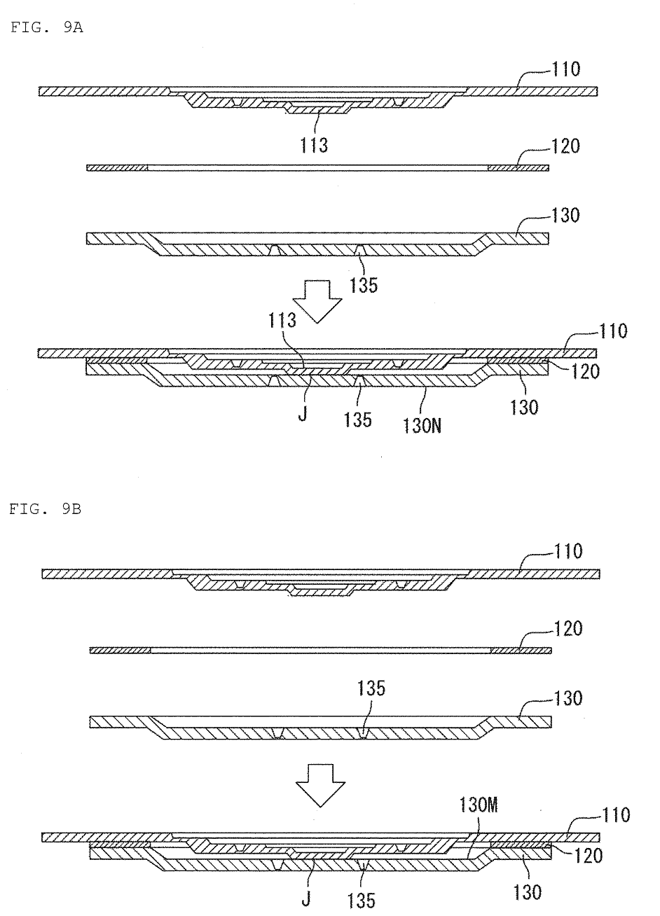

As shown in the sectional view of FIGS. 9A and 9B, the stripper disk 130 corresponding to the second metal member has the second groove 135. As will be described later, in one example, as illustrated in FIG. 9A, the second groove 135 is provided on the inner surface of the stripper disk 130, particularly on the inner surface in the battery axial direction 130N that is the inner side when viewed along the battery axial direction. In another example, as illustrated in FIG. 9B, the second groove 135 is provided on the outer surface of the stripper disk 130, particularly on the outer surface in the battery axial direction 130M that is the outer side when viewed along the battery axial direction.

In the second metal member, the second groove may be positioned on the outer peripheral side of the interconnection portion between the first metal member and the second metal member. That is, in the stripper disk 130 corresponding to the second metal member, the second groove 135 may be positioned farther from the battery axis than the interconnection portion J between the safety cover 110 and the stripper disk 130.

The second groove 135 may have a notched form or a carved form in a sectional view. Similarly, the second groove 135 may have a shoulder contour that forms a pair in a sectional view because of the groove (refer to FIGS. 9A and 9B). It can also be said that the second groove may have a line-symmetric contour in a sectional view. For example, the second groove 135 may be a so-called “imprint groove” or a groove formed through press molding. In addition, because of the groove, the second groove may have a depth of half or more of the thickness of the member. That is, the groove depth dimension of the second groove may be half or more of the thickness dimension of the second metal member. Herein, the thickness of the second metal member refers to, for example, a member thickness of a portion located on the outer peripheral side of the second groove. In combination with the “step portion”, “thin portion”, and “first groove provided on the outer surface of the first metal member”, such a second groove can effectively provide stress for displacement of the stripper disk, which contributes to improvement of the displacement amount of the stripper disk at the time of operation of the safety valve.

As described above, in the safety valve having the “configuration in which first metal member has a step portion and thin portion, the first groove is provided on the inner surface of the first metal member, and the second groove is provided on the second metal member”, it is possible to improve the displacement amount of the stripper disk accompanying the breakage at the time of current interruption. For example, as can be seen from the results of Examples described later, the displacement amount of the second metal member at the time of the operation of the safety valve can be larger, thereby easily suppressing and avoiding re-conduction. More specifically, for example, the displacement amount of the stripper disk due to breakage at the time of operation of the safety valve can be larger, thereby easily suppressing and avoiding re-conduction between the stripper disk and the safety cover. That is, adopting the specific safety valve configuration as described above easily suppresses or avoids undesired re-conduction at the time of operation of the safety valve, and a battery with higher reliability is easily provided.

The effect of easily suppressing and avoiding such disadvantageous re-conduction easily manifests when fusing occurs. When breakage of the second metal member at the time of operation of the safety valve occurs due to fusing (for example, when fusing occurs due to application of a large current or the like), re-conduction can be caused by disadvantageously disposing molten metal causing fusing so as to contact between the first metal member and the second metal member. However, when the displacement amount of the second metal member at the time of operation of the safety valve is larger, such a disadvantageous arrangement of the molten metal is more effectively suppressed or easily avoided, and in this respect, the re-conduction is easily suppressed and avoided. That is, when the displacement amount of the stripper disk after breakage at the time of operation of the safety valve is larger, it becomes easy to suppress or avoid a disadvantageous phenomenon such as “molten metal that may be generated by fusing is disposed so as to contact between the first metal member and the second metal member”, and it becomes easy to more effectively suppress and avoid re-conduction.

In a preferred aspect, the first metal member has a central convex portion in which a central region on the inner peripheral side of the thin portion protrudes toward the battery inner side (that is, the inner side when viewed along the battery axial direction), and the second groove is positioned on the outer peripheral side of the central convex portion in the second metal member. That is, in the second metal member, the second groove may be positioned the outer side of the central convex portion in a direction away from the battery axis with respect to the central convex portion. More specifically, as illustrated in FIGS. 9A and 9B, the safety cover 110 corresponding to the first metal member has a central convex portion 113 relatively protruding on an inner side in the battery axial direction in the central region thereof, and the second groove 135 may be provided in a region located on the outer peripheral side of the central convex portion 113 (region of the stripper disk 130 corresponding to the second metal member). According to such an aspect, an effect of reducing or avoiding an undesirable displacement at the time of operation of the safety valve easily manifests, and further, suppression and avoidance of re-conduction involving molten metal due to fusing also easily manifest. More specifically, the effect of improving the displacement amount of the stripper disk due to the breakage of the second metal member at the time of current interruption easily becomes manifest, and therefore, suppression and avoidance of re-conduction involving molten metal in fusing also easily become manifest.

In a preferred aspect, the second groove is provided on the inner surface (that is, inner surface in the battery axial direction) of the second metal member. In other words, the second groove provided in the second metal member may be a groove having an opening toward the inner side when viewed along the battery axis. That is, the second groove may be a groove in which the groove opens in a surface relatively proximal to the electrode assembly side of the member surfaces of the second metal member. More specifically, as illustrated in FIG. 9A, the second groove 135 is provided on the inner surface 130N of the stripper disk 130 corresponding to the second metal member. As illustrated in the drawing, it can be said that the imprint plane of the second groove of the second metal member faces upward. In this aspect, the displacement amount of the safety valve at the time of operation of the safety valve can be improved. In combination with the “step portion”, “thin portion”, and the presence of the “first groove provided on an outer surface of the first metal member”, the second groove provided on the inner surface of the second metal member can effectively provide stress for displacement of the stripper disk, which contributes to improvement of the displacement amount of the stripper disk at the time of operation of the safety valve. That is, the second groove provided on the inner surface of the second metal member in the battery axial direction contributes to improvement of the displacement amount of the safety valve, and consequently, it is easy to more effectively suppress and avoid re-conduction involving molten metal with fusing. More specifically, the displacement amount of the stripper disk due to breakage of the second metal member at the time of current interruption can be more effectively improved, and therefore, re-conduction involving molten metal with fusing is easy to be more effectively suppressed and avoided.

In another preferred aspect, the second groove is provided on the outer surface (that is, outer surface in the battery axial direction) of the second metal member. In other words, the second groove provided in the second metal member may be a groove having an opening toward the outer side when viewed along the battery axis. That is, the second groove may be a groove in which the groove opens in a surface relatively proximal to the top cover side of the member surfaces of the second metal member. More specifically, as illustrated in FIG. 9B, the second groove 135 is provided on the outer surface 130M of the stripper disk 130 corresponding to the second metal member. As illustrated in the drawing, it can be said that the imprint plane of the second groove of the second metal member faces downward. In this aspect, the displacement amount of the safety valve at the time of operation of the safety valve can be improved. In combination with the “step portion”, “thin portion”, and the presence of the “first groove provided on the first metal member”, the second groove provided on the outer surface of the second metal member can effectively provide stress for displacement of the stripper disk, which contributes to improvement of the displacement amount of the stripper disk at the time of operation of the safety valve. That is, the second groove provided on the outer surface of the second metal member in the battery axial direction contributes to improvement of the displacement amount of the safety valve, and consequently, it is easy to more effectively suppress and avoid re-conduction involving molten metal with fusing. More specifically, the displacement amount of the stripper disk due to breakage of the second metal member at the time of current interruption can be more effectively improved, and therefore, re-conduction involving molten metal with fusing is easy to be more effectively suppressed and avoided.

The first metal member may have a form of protruding toward the inner side of the battery in two stages. More specifically, the first metal member may protrude toward the inner side of the battery starting from the step portion, and the above-described central convex portion may be provided such that the central region protrudes further toward the inner side of the battery than the protrusion. The aspect shown in FIG. 7 shows a form in which the protrusion portion 112 is provided by the safety cover 110 protruding toward the inner side of the battery starting from the step portion 111, and the central convex portion 113 is additionally provided with respect to the protrusion portion 112. That is, the form is that the central convex portion 113 protrudes from the protruding portion 112 on the inner peripheral side of the thin portion. In such an aspect, it is desirable in that while the first metal member and the second metal member secure the connection with each other in the central region thereof, the separation state between the first metal member and the second metal member is more suitably secured in the other regions. That is, the two-step protrusion of the safety cover can contribute to improvement of the interruption reliability in the thin safety valve.

The second metal member may also have a form of protruding into the inner side of the battery. More specifically, in the second metal member, a region on the inner side of the peripheral edge portion may protrude toward the inner side of the battery. In the aspect shown in FIG. 7, the stripper disk 130 corresponding to the second metal member has a convex portion 133 in which a region on the inner peripheral side of the peripheral edge portion 132 protrudes. A central convex portion of the first metal member, preferably a central convex portion 113 (refer to FIG. 7) provided on the protruding portion 112 may be connected to the convex portion of the stripper disk. That is, in one aspect, the second metal member may have a convex portion protruding toward the inner side of the battery, and the central convex portion of the first metal member may be connected to the convex portion (particularly, the upper surface thereof) of the second metal member. In such an aspect, the above-described matter such as “while the connection between the first metal member and the second metal member is secured in the central region of the first metal member and the second metal member, the separation state between the first metal member and the second metal member is more suitably secured in the other regions” can be more manifest. That is, the connection between the protrusions of the two metal members can make the improvement in the interruption reliability of the thin safety valve more manifest.

In a preferred aspect, the thin portion of the first metal member has a positional relationship in which the thin portion at least partly overlaps the second groove of the second metal member in the battery axial direction. In other words, the thin portion of the first metal member and the second groove of the second metal member have a positional relationship in which the thin portion of the first metal member and the second groove of the second metal member are disposed side by side in the battery axial direction. In the aspect shown in FIG. 7, the second groove 135 of the stripper disk 130 corresponding to the second metal member is aligned in the battery axial direction with the thin portion 116 of the safety cover 110 corresponding to the first metal member. In such an aspect, the first metal member and the second groove of the second metal member in which fusing occurs can be in a more separated positional relationship, and thus re-conduction particularly caused by molten metal is easy to be more effectively suppressed and avoided. That is, when the thin portion of the first metal member has a positional relationship in which the thin portion at least partly overlaps with the second groove of the second metal member in the battery axial direction, it is easy to suppress or avoid a disadvantageous phenomenon such as “molten metal of fusion is disposed so as to contact between the first metal member and the second metal member” at the time of operation of the safety valve, and the re-conduction is easy to be more effectively suppressed and avoided.

In the safety valve provided in the battery of the present disclosure, as described above, the first metal member, the second metal member, and the insulating member are combined so as to be stacked together with the top cover, the insulating member has a hollow portion or a cavity, and the first metal member and the second metal member are connected with the hollow portion or the cavity of the insulating member interposed therebetween. Such a configuration at least results in a thin safety valve, and in combination with the characteristic of “configuration in which the first metal member has a step portion and thin portion, the first groove is provided on outer surface of the first metal member, and the second groove is provided on the second metal member”, the displacement amount of the safety valve at the time of operation can be improved, and consequently it is easy to suppress and avoid re-conduction involving molten metal that can be caused by fusing. That is, in the thin safety valve suitable according to the present disclosure, it is easy to suppress or avoid a disadvantageous phenomenon such as “molten metal caused by fused is disposed so as to disposed between the first metal member and the second metal member” at the time of operation, and it is easy to more effectively suppress and avoid re-conduction.

In a preferred aspect, the top cover provided outside the first metal member has a convex portion that protrudes on the outer side in the battery axial direction, and the second groove of the second metal member is positioned on the inner peripheral side of a protrusion origin of the convex portion of the top cover and on the outer peripheral side of the central connection portion between the first metal member and the second metal member. That is, when the battery further includes a top cover that is provided on the outer side in the battery axial direction relative to the first metal member and includes a convex portion that protrudes outward in the battery axial direction, the step portion may be suitably provided on the first metal member in consideration of the balance with the top cover. Specifically, the second groove may be positioned in a region of the second metal member on the inner peripheral side of the protrusion origin of the protrusion portion of the top cover and on the outer peripheral side of the central connection portion between the first metal member and the second metal member.

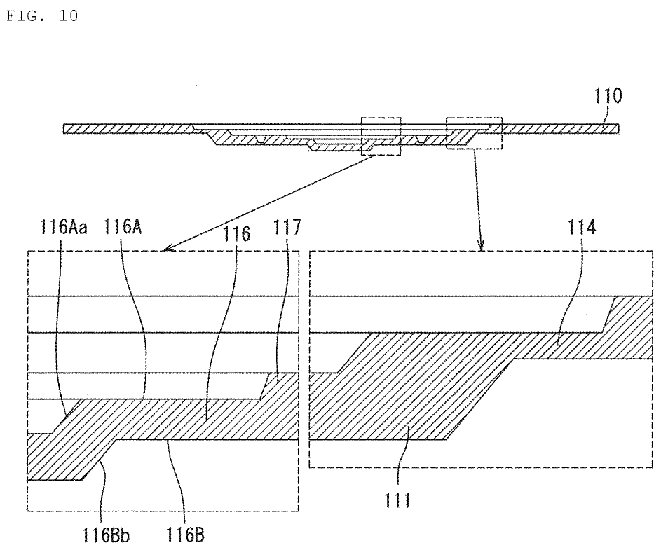

In a preferred aspect, the first metal member has a form of a specific step portion, and the thin portion may also have a specific form. Specifically, in the first metal member, the step portion may be configured with a thin form, and the thin portion may be configured with a step form. In the aspect of the safety cover 110 illustrated in FIG. 10, the step portion 111 includes a thin portion 114 having a relatively reduced thickness as compared with other portions. The thin portion, that is, the thin portion in which the thickness is relatively reduced in the step portion 111 is the portion denoted by reference numeral 114, and the step portion 111 is configured together with the thin portion. Due to at least the installation of the step portion, a suitable displacement is easily imparted to the stripper disk corresponding to the second metal member at the time of operation of the safety valve.

Similarly, in the aspect of the safety cover illustrated in FIG. 10, the thin portion 116 provided on the inner peripheral side of the step portion may be configured so as to be included in another step portion 117. In the illustrated aspect, the thin portion is a portion denoted by reference numeral 116, and another step portion 117 is formed so as to include the portion 116 or together with the portion 116. As can be seen from the illustrated aspect, in another step portion 117, the outer contour 116A of the first metal member located relatively on the outer side in the battery axial direction may have a step contour 116Aa, and the inner contour 116B of the first metal member located relatively on the inner side in the battery axial direction may also have a step contour 116Bb (refer to the lower left view of FIG. 10). Such a thin portion with another step portion is desirable in that while the first metal member and the second metal member more suitably ensure the separation state of each other in a region other than the central region, the connection therebetween is easily ensured in the central region.

That is, in the aspect shown in FIG. 10, the step portion may be configured with a thin form, and the thin portion can be configured with a step form. The first metal member forms a convex portion on the battery element body side by the step portion, and the convex portion having the two-step configuration is formed so as to form a convex portion on the battery element body side by the step form of the “thin portion”.

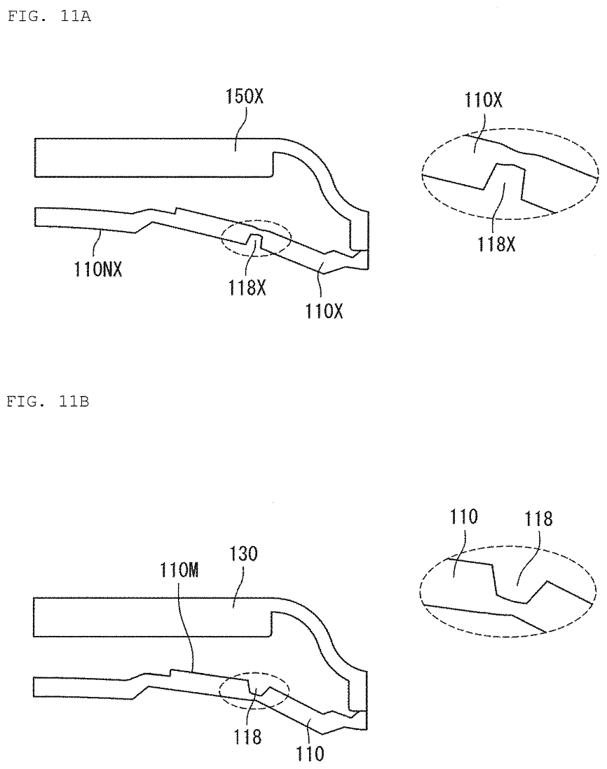

Herein, an effect of the first groove will be described. Specifically, the effect of the first groove provided not on the inner main surface of the first metal member but on the outer main surface (surface located on the outer side when viewed along the battery axial direction) will be described in detail. The safety cover corresponding to the first metal member can be deformed so as to be bent at the time of operation of the safety valve. Herein, when the first groove 118 is provided on the inner main surface 110NX of the safety cover 110, stress can act in a direction in which a portion close to the inner side of the groove contracts, and stress can act in a direction in which a portion close to the outer side of the groove extends (refer to FIG. 11A). Therefore, the groove is hardly cleaved at the end, and the variation in cleavage pressure can be increased. In addition, the safety cover itself is easily deformed linearly, and easily comes into contact with the top cover, which increases the possibility that the safety cover is not cleaved. In contrast, when the first groove 118 is provided on the outer main surface 110M of the safety cover 110, stress can act in a direction in which both a portion close to the inner side and a portion close to the outer side of the groove extend (refer to FIG. 11B). Therefore, the groove is easily cleaved, and variation in cleavage pressure can be reduced. In addition, the safety cover itself is deformed while being further bent, and thus it is easy to secure a state of being separated from the top cover, and it is possible to effectively avoid an “event in which the safety cover is not cleaved due to contact with the top cover”.

A method for producing a battery according to the present disclosure will be exemplarily described by employing a method for producing a secondary battery as an example according to an embodiment. The secondary battery of the present disclosure can be produced by the following procedure, for example.

In the production of a positive electrode, a positive electrode active material is, as necessary, mixed with a positive electrode binder, a positive electrode conductive agent, and the like to obtain a positive electrode mixture. Subsequently, the positive electrode mixture is dispersed in, for example, an organic solvent to obtain a positive electrode mixture slurry in a paste form. Then, the positive electrode mixture slurry is applied to one side or both sides of the positive electrode current collector, and the positive electrode mixture slurry is dried to form a positive electrode active material layer. Thereafter, as necessary, the positive electrode active material layer may be compression-molded using a roll press machine or the like. In such a case, the positive electrode active material layer may be heated, or compression molding may be repeated multiple times. In the same manner, a negative electrode can be produced. Specifically, a negative electrode active material, and, for example, a negative positive electrode binder and the negative electrode conductive agent are mixed to obtain a negative electrode mixture. Subsequently, the negative electrode mixture is dispersed in, for example, an organic solvent to obtain a negative electrode mixture slurry in a paste form. Then, a negative electrode active material layer is formed by applying the negative electrode mixture slurry to one or both surfaces of the negative electrode current collector and then drying the negative electrode mixture slurry. Thereafter, as necessary, the negative electrode active material layer is compression-molded using a roll press machine or the like.

When a secondary battery is assembled, for example, the positive electrode lead is connected to the positive electrode current collector by a welding method and the like as well as the negative electrode lead is connected to the negative electrode current collector by a welding method and the like. Subsequently, the positive electrode and the negative electrode are stacked with the separator interposed therebetween, and then, the positive electrode, the negative electrode, and the separator are wound to form the wound electrode body.

Subsequently, the center pin is inserted in the winding space of the wound electrode body. Then, the wound electrode body is sandwiched between a pair of insulating plates, and is contained inside the battery can together with the pair of insulating plates. In this case, one end of the positive electrode lead is coupled to the safety valve by, for example, a welding method, and similarly, one end of the negative electrode lead is coupled to the battery can by, for example, a welding method. Then, an electrolytic solution is injected into the battery can, and the wound electrode body is impregnated with the electrolytic solution. Finally, a safety valve is provided at the opening end portion of the battery can with, for example, a holder member interposed therebetween. A secondary battery provided with a safety valve is thus completed.

The step portion, the thin portion, and the groove (that is, the first groove) provided in the first metal member and the groove (that is, the second groove) provided in the second metal member according to the present disclosure can be provided at the time of press molding each of the first metal member and the second metal member. In addition, the element can be formed not only by press molding but also by other methods such as mechanical grinding and laser processing.

Although one or more embodiments of the present disclosure have been described herein, the present disclosure is not limited thereto.

For example, although the cylindrical battery has been mainly described above, the present disclosure is not necessarily limited thereto. For example, the battery according to the present disclosure may be a battery having another shape such as a prismatic battery, and the effect of the present disclosure can be similarly exhibited.

In the above description, the battery can, that is, the exterior body of the battery has been mentioned in the description of the present disclosure, but such an exterior body may have a beadless structure without a beading portion. The beadless exterior body does not have a narrowed or constricted portion inside the exterior body (particularly, near the battery axis side), it is possible to secure a wider space for arranging the electrode assembly inside the exterior body. That is, a beadless exterior can or the like in which the inner diameter dimension of such a battery can is substantially constant along the battery axis can contribute to realization of a battery having a higher energy density.

The present disclosure, in an embodiment, relates to providing a safety valve having an unprecedented configuration, and the battery of the present disclosure has the following aspects according to an embodiment.

<1> A battery (for example, a primary battery or a secondary battery) having a safety valve (or a safety valve structure, a battery safety valve, or a safety valve structure), the battery including:
the safety valve including a first metal member located on an outer side, a second metal member located on an inner side, and an insulating member located between the first metal member and the second metal member, and the first metal member and the second metal member being connected to each other such that the first metal member and the second metal member straddle the insulating member;
the first metal member including a step portion and a thin portion positioned on an inner peripheral side of the step portion;
the first metal member including a first groove;
the second metal member including a second groove; and
the first groove provided on an outer surface of the first metal member.

<2> The battery according to <1>, in which the second groove is provided on an inner surface of the second metal member.

<3> The battery according to <1>, in which the second groove is provided on an outer surface of the second metal member.

<4> The battery according to any one of <1> to <3>, in which the first metal member has a central convex portion in which a central region on an inner peripheral side of the thin portion protrudes toward an inner side of the battery, and the second groove of the second metal member is positioned on an outer peripheral side of the central convex portion.

<5> The battery according to <4>, in which an inner peripheral region of the first metal member protrudes toward the inner side of the battery from the step portion, and the central convex portion is provided such that the central region protrudes further toward the inner side of the battery than the protrusion.

<6> The battery according to any one of <1> to <5>, in which the thin portion of the first metal member has a positional relationship in which the thin portion at least partly overlaps the second groove of the second metal member in the battery axial direction.

<7> The battery according to any one of <1> to <6>, in which in the safety valve, the first metal member, the second metal member, and the insulating member are combined so as to be stacked together with a top cover, the insulating member has a hollow portion or a cavity, and the first metal member and the second metal member are connected with the hollow portion or the cavity of the insulating member interposed therebetween.

<8> The battery according to any one of <1> to <7>, in which a top cover provided on an outer side of the first metal member has a convex portion that protrudes on an outer side in a battery axial direction, and the second groove is positioned on an inner peripheral side of protrusion origin of the convex portion of the top cover and on an outer peripheral side of a central connection portion between the first metal member and the second metal member.

<9> The battery according to any one of <1> to <8>, in which the insulating member includes a resin material.

<10> The battery according to any one of <1> to <9>, in which the battery includes a positive electrode and a negative electrode capable of occluding and releasing lithium ions.

Hereinafter, the present disclosure will be described using Examples according to an embodiment. The present disclosure is not limitedthereto.

The following software was utilized and which is general-purpose software widely used in various technical fields and has high reliability.
ANSYS coupled analysis software: Ansys Mechanical
   Verification target: Safety valve with static structure (2D half-split model illustrated in FIG. 12).
   Material condition of each component of safety valve
      Top cover (safety valve lid member): Structural steel
      Safety cover (first metal member): Aluminum alloy
      Stripper disk (second metal member): Aluminum alloy
      Insulating member: Resin PBT (polybutylene terephthalate)
   Pressure setting: 0.1 MPa/s
   Displacement amount evaluation pressure: 10 MPa

### Example 1

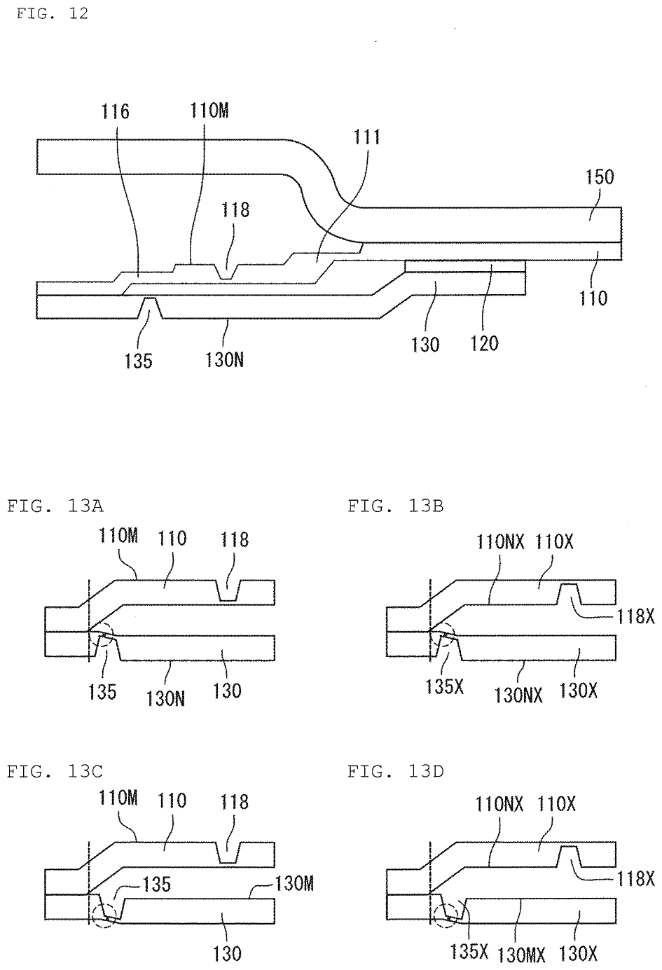

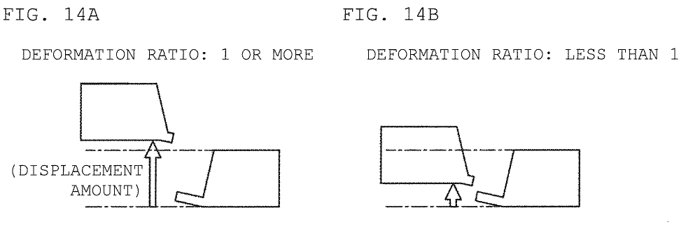

Basic configuration: A safety valve having a basic configuration illustrated in FIG. 13, the safety valve including a safety cover 110 disposed on the outer side in the battery axial direction, a stripper disk 130 disposed on the inner side in the battery axial direction, and an insulating member 120 disposed between the safety cover and the stripper disk.

As illustrated in FIG. 13, the safety cover 110 has a step portion 111 and a thin portion 116 positioned on the inner peripheral side of the step portion.
Groove configuration: A case (refer to FIGS. 12 and 13 (a)) in which the second groove 135 is provided in the stripper disk 130 corresponding to the second metal member, the second groove 135 is provided on the inner surface in the battery axial direction 130N in which the orientation and position of the second groove are “upward”/“upper surface”, the first groove 118 is provided in the safety cover 110 corresponding to the first metal member, and the first groove 118 is provided on the outer surface in the battery axial direction 110M in which the orientation and position of the first groove are “downward”/“lower surface”.

### Example 2

The safety valve is the same as that of Example 1 except that the configuration is changed to the following groove configuration.
Groove configuration: A case (refer to FIGS. 12 and 13(b)) in which the second groove of the stripper disk corresponding to the second metal member is provided, the second groove is provided on the outer surface in the battery axial direction 130M (refer to FIG. 12) in which the orientation and position of the second groove are “downward”/“lower surface”, the first groove is provided on the safety cover corresponding to the first metal member, and the first groove is provided on the outer surface in the battery axial direction 110M in which the orientation and position of the first groove are “downward”/“lower surface”.

### Comparative Example 1

The safety valve is the same as that of Example 1 except that the configuration is changed to the following groove configuration.
Groove configuration: A case (refer to FIG. 13(c)) in which the second groove of the stripper disk corresponding to the second metal member is provided, the second groove is provided on the inner surface in the battery axial direction 130NX in which the orientation and position of the second groove are “upward”/“upper surface”, the first groove is provided on the safety cover corresponding to the first metal member, and the first groove is provided on the inner surface in the battery axial direction 110NX in which the orientation of the first groove is “upward”/“upper surface”.

### Comparative Example 2

The safety valve is the same as that of Example 1 except that the configuration is changed to the following groove configuration.
Groove configuration: A case in which the second groove of the stripper disk corresponding to the second metal member is provided, the second groove is provided on the outer surface in the battery axial direction 130MX in which the direction and position of the second groove are “downward”/“lower surface”, the first groove is provided on the safety cover corresponding to the first metal member, and the first groove is provided on the inner surface in the battery axial direction 110NX in which the direction and position of the first groove are “upward”/“upper surface” (refer to FIG. 13(d)).

As the evaluation, the following displacement amount and deformation ratio were used as evaluation indices.
Displacement amount S [mm]: Displacement distance (refer to FIG. 14) with reference to a central portion of a lower surface (inner surface in the battery axial direction) of the stripper disk corresponding to the second metal member as described above.
Deformation ratio R [−]: Deformation rate (that is, R=0.4/S) based on base material thickness (0.4 mm) of stripper disk corresponding to second metal member

The results are shown in Table 1 below.

TABLE 1

| | Conditions of groove portion | | | |
|---|---|---|---|---|
| | (SC/first | (STD/second | Results | |
| | metal member) | metal member) | S | R |
| | Direction of first | Direction of second | Displacement | Deformation |
| | groove portion | groove portion | amount S [mm] | ratio R [—] |
| Example 1 | Inner surface | Outer surface | 0.64 | 1.60 |
| | (Below surface/ | (On surface/ | | |
| | lower surface) | upper surface) | | |
| Example 2 | Inner surface | Inner surface | 0.65 | 1.63 |
| | (Below surface/ | (Below surface/ | | |
| | lower surface) | lower surface) | | |
| Comparative | Outer surface | Inner surface | 0.34 | 0.85 |
| Example 1 | (On surface/ | (Below surface/ | | |
| | upper surface) | lower surface) | | |
| Comparative | Outer surface | Outer surface | 0.35 | 0.88 |
| Example 2 | (On surface/ | (On surface/ | | |
| | upper surface) | upper surface) | | |

The following matters were found from the results of Table 1.
A safety valve in which “the first metal member (stripper disk) has a step portion and a thin portion positioned on the inner peripheral side of the step portion”, and when the first metal member has the first groove, the second metal member has the second groove, and the first groove is provided on the outer surface of the first metal member in the battery axial direction (Examples 1 and 2), the deformation ratio is relatively large (the deformation ratio is increased by 82% to 92%) as compared with the case where the first groove is not provided (Comparative Examples 1 and 2), and thus it is easy to suppress or avoid a disadvantageous decrease in the displacement amount of the stripper disk due to breakage. That is, undesired re-conduction at the time of operation of the safety valve can be more easily suppressed and avoided, and a more reliable battery can be obtained.
In particular, Example 1 is a case where “the second groove is provided on the inner surface of the second metal member (safety cover) in the battery axial direction”, and Example 2 is a case where “the second groove is provided on the outer surface of the second metal member (safety cover) in the battery axis direction”. When such a second groove is provided on the outer surface and when such a second groove is provided on the inner surface, the deformation ratio is relatively large as compared with Comparative Example 1 and Comparative Example 2 (refer to FIG. 14(b)), and in Example 1 and Example 2 (refer to FIG. 14(a)), it is easy to suppress or avoid a disadvantageous decrease in the displacement amount of the stripper disk due to breakage. That is, undesired re-conduction at the time of operation of the safety valve can be more easily suppressed and avoided, and a more reliable battery can be obtained.

The effects and the like of the above-described Examples are merely one example. Therefore, the present disclosure is not limited to the above matters, and may have an additional effect.

The battery (battery such as a primary battery or a secondary battery) according to the present disclosure can be typically used for applications in which use of electric energy is required. For example, a secondary battery according to the present disclosure can be used in various fields in which electric storage is assumed. The battery of the present disclosure can be used in the fields of electricity, information, and communication in which electrical/electronic equipment and the like are used (for example, the fields of electrical/electronic equipment and mobile equipment including mobile phones, smartphones, notebook computers, digital cameras, activity meters, arm computers, electronic paper, wearable devices, and small electronic machines such as RFID tags, card type electronic money, and smartwatches), home and small industrial applications (for example, the fields of electric tools, golf carts, and home, nursing, and industrial robots), large industrial applications (for example, the fields of forklifts, elevators, and harbor cranes), transportation system fields (for example, the fields of hybrid vehicles, electric vehicles, buses, trains, power-assisted bicycles, electric two-wheeled vehicles), power system applications (for example, the fields of various types of power generation, road conditioners, smart grids, and household power storage systems), medical applications (the field of medical equipment such as earphone hearing aids), pharmaceutical applications (the fields of dosage management systems and the like), IoT fields, space and deep sea applications (for example, the fields of space probes and submersibles), and the like, as merely examples.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising a safety valve,
the safety valve including a first metal member located on an outer side, a second metal member located an inner side, and an insulating member located between the first metal member and the second metal member, and the first metal member and the second metal member being connected to each other such that the first metal member and the second metal member straddle the insulating member,
the first metal member including a step portion and a thin portion located on an inner peripheral side of the step portion, and
the first metal member having a first groove, the second metal member having a second groove, and the first groove being provided on an outer surface of the first metal member.

2. The battery according to claim 1, wherein the second groove is provided on an inner surface of the second metal member.

3. The battery according to claim 1, wherein the second groove is provided on an outer surface of the second metal member.

4. The battery according to claim 1, wherein the first metal member has a central convex portion in which a central region on an inner peripheral side of the thin portion protrudes toward an inner side of the battery, and the second groove of the second metal member is positioned on an outer peripheral side of the central convex portion.

5. The battery according to claim 4, wherein an inner peripheral region of the first metal member protrudes toward the inner side of the battery from the step portion, and the central convex portion is provided such that the central region protrudes further toward the inner side of the battery than the protrusion.

6. The battery according to claim 1, wherein the thin portion of the first metal member has a positional relationship in which the thin portion at least partly overlaps the second groove of the second metal member in a battery axial direction.

7. The battery according to claim 1, wherein in the safety valve, the first metal member, the second metal member, and the insulating member are combined so as to be stacked together with a top cover, the insulating member has a hollow portion or a cavity, and the first metal member and the second metal member are connected with the hollow portion or the cavity of the insulating member interposed therebetween.

8. The battery according to claim 1, wherein the top cover provided on an outer side of the first metal member has a convex portion that protrudes on an outer side in a battery axial direction, and the second groove is positioned on an inner peripheral side of protrusion origin of the convex portion of the top cover and on an outer peripheral side of a central connection portion between the first metal member and the second metal member.

9. The battery according to claim 1, wherein the insulating member includes a resin material.

10. The battery according to claim 1, wherein the battery includes a positive electrode and a negative electrode capable of occluding and releasing lithium ions.
